(19) United States
(12) Patent Application Publication
(10) Pub. No.: US 2004/0193647 A1
(43) Pub. Date: Sep. 30, 2004

(54) Av data transmitter, av data receiver, and av data displaying/reproducing apparatus

(76) Inventors: Toru Ueda, Souraku-gun (JP); Kazuya Oyama, Ikoma-shi (JP)

Correspondence Address: BIRCH STEWART KOLASCH & BIRCH, PO BOX 747, FALLS CHURCH, VA, 22040-0747, US

(21) Appl. No.: 10/482,800

(22) PCT Filed: Jul. 4, 2002
(86) PCT No.: PCT/JP02/06827

(30) Foreign Application Priority Data
Jul. 10, 2001 (JP) 2001-209787

(51) Int. Cl. G06F 17/00

(52) U.S. Cl. 707/104.1

(57) ABSTRACT

An AV data transmitter for transmitting AV data wirelessly and transmitting/receiving asynchronous data. The transmitter has a quality variation setting section for varying the compression ratio of the AV data and for changing the communication band for the AV data transmission or reliability of the communication. Further the transmitter has an AV data transmission switch for enabling switching even during communication.

### TECHNICAL FIELD

The present invention relates to an AV (audiovisual) data transmitting apparatus, AV data receiving apparatus, and AV data displaying/reproducing apparatus for displaying/reproducing images, music, and sounds.

### BACKGROUND ART

Conventional apparatuses for receiving AV data and for transmitting control commands for controlling an image-source-side unit are disclosed, for example, in Japanese Patent Applications Laid-Open Nos. H9-74498 and 2000-251456. In the apparatuses disclosed in these publications, a sub AV unit is given capabilities of receiving AV data that is transmitted thereto wirelessly and of transmitting control commands that it receives from an infrared remote control transmitter to a main AV unit wirelessly.

The publications mentioned above disclose that such capabilities are achieved, for example, through wireless transmission based on the spread-spectrum principle in the 2.4 GHz band, but disclose nothing about how the image quality is controlled. Since only a limited amount of data (bandwidth) can be transmitted wirelessly per unit time, when a plurality of users attempt to transmit data simultaneously, if one of the users occupies a large part of the available bandwidth to transmit high-quality image data, the other users are not allowed satisfactorily high transmission rates. Moreover, when wireless reception is poor, data errors or data loss occurs, making proper reproduction of images impossible.

An AV data receiving apparatus exploits radio waves, which can be transmitted even by being reflected. Thus, the AV data receiving apparatus need not necessarily be placed in the range visible from the user. However, when infrared light is used, as in infrared remote control, an infrared receiver needs to be placed in the range visible from the remote control transmitter held by the user.

If all infrared commands are transmitted via a wireless route, the wrong units may be controlled on the command-receiving side. In a case where an AV data receiving apparatus alone is housed in a cabinet, and in addition it is used in combination with a portable AV data displaying/reproducing apparatus such as a flat display, when the AV data receiving apparatus is carried around, it needs to be carried separately from a liquid crystal television monitor.

In a case where an AV data receiving apparatus and an AV data displaying/reproducing apparatus are operated by infrared remote control, those apparatuses cannot be fully operated without the use of an infrared remote control transmitter. Accordingly, when the AV data receiving apparatus and the AV data displaying/reproducing apparatus are carried around, their infrared remote control transmitters need to be carried together therewith.

### DISCLOSURE OF THE INVENTION

An object of the present invention is to provide an apparatus that permits easy and convenient use of an AV data displaying/reproducing apparatus when it is controlled wirelessly via an AV data receiving apparatus by infrared remote control.

According to the present invention, when wireless reception is so poor that images cannot be reproduced properly, the image transfer rate is lowered so that more of the transfer capacity is allotted to re-transmission. This makes it possible to avoid data errors and data loss. A wireless system usually offers a plurality of transfer channels, and, if the user is permitted to change channels at will, even when a given channel is interfered by an interfering wave and images cannot be reproduced properly on that channel, the user can avoid the interference by changing channels.

According to the present invention, an AV data transmitting apparatus wirelessly transmits AV data in the form of digital data, and transmits and receives asynchronous data via a wireless route. The AV data transmitting apparatus is provided with a quality change setter for changing the compression ratio of the AV data, and the quality change setter permits the communication bandwidth for AV data transmission to be changed. The quality change setter permits not only the compression ratio of the AV data but also the reliability of communication to be changed. Thus, it is possible to change the quality of AV data, and as a result it is possible to change the bandwidth for AV data transfer or the reliability of communication. By changing the bandwidth for AV data transfer, it is possible to increase or decrease the bandwidth used by another application. Alternatively, the bandwidth freed by lowering the quality of AV data can be used to increase the reliability of communication and thereby reduce communication errors in AV data.

According to the present invention, an AV data transmitting apparatus is provided with a channel switcher. The channel switcher is added to the transmitting apparatus, and is switchable even during communication. This permits the user to change channels easily.

According to the present invention, an AV data transmitting apparatus uses, as a wireless route, the 2.4 GHz band (from 2 400 MHz to 2 497 MHz), and permits the user to use channels that include a part of the band above the 13th channel (with a central frequency of 2 472 MHz). In a wireless system that uses the 2.4 GHz band, by permitting the use of a channel in a part of the band above the 13th channel, it is possible to perform data transfer away from the 1st to 13th channels, which are used by the Bluetooth system, which also uses the 2.4 GHz band. When IEEE802.11b, a LAN technology that uses the 2.4 GHz band, is used, using channels outside the frequency shift range of the Bluetooth system makes it possible to reduce the effects thereof.

According to the present invention, an AV data transmitting apparatus wirelessly transmits AV data in the form of digital data, and transmits and receives asynchronous data via a wireless route. The AV data transmitting apparatus is provided with a command converter for selecting control data from the asynchronous data and converting the selected control data according to a predetermined rule, and a command transmitter for feeding the commands obtained through conversion by the command converter via an AV data receiving apparatus to an external apparatus such as a flat display or an AV data displaying/reproducing apparatus such as a liquid crystal television monitor. The command transmitter may be built as an IR command transmitter.

This makes it possible to convert the control commands transmitted via the wireless route into a format that suits the external apparatus and then transmit them to the external apparatus. By making the conversion rule rewritable, it is possible to convert the control commands into different formats that suit different external apparatuses.

According to the present invention, an AV data receiving apparatus has a command receiver that is movable. Even in a case where the AV data receiving apparatus is fitted to the rear face of an AV data displaying/reproducing apparatus such as a flat display, a photoreceiver can be so placed as to permit the user to operate the AV data displaying/reproducing apparatus by remote control from in front thereof while viewing the image on the screen.

According to the present invention, an AV data receiving apparatus is provided with an external antenna interface and an infrared photoreceiver interface. This makes it possible to add an external antenna for more error-free communication. Arranging the external antenna interface and the infrared photoreceiver interface on the same face makes it easy for the user to plug in the connecting plugs for both the external antenna and the infrared photoreceiver.

According to the present invention, an AV data receiving apparatus is provided with a switch for generating operation commands. This makes it possible to control the AV data receiving apparatus and an AV data output apparatus from a distance without an infrared remote control transmitter.

According to the present invention, an AV data receiving apparatus has switches and connectors arranged so as not to obstruct the maximum gain plane of the antenna. This helps prevent the radio waves from being interfered by a switch or the like, and thus helps enhance communication performance.

According to the present invention, an AV data receiving apparatus is provided with a power supply interface for feeding electric power to an AV data displaying/reproducing apparatus. This makes it possible to display and reproduce AV data without connecting the AV data displaying/reproducing apparatus to an AC power source.

Additionally providing a mechanism that permits the AV data receiving apparatus to be fitted to the AV data displaying/reproducing apparatus makes it possible to carry around the AV data receiving apparatus together with the AV data displaying/reproducing apparatus as a single unit.

According to the present invention, an AV data receiving apparatus is provided with a header discriminator, an IP packet discriminator, and an IP application executer. This makes it possible to visually and acoustically enjoy both Internet applications and AV data.

### BRIEF DESCRIPTION OF DRAWINGS

FIG. 1 is a diagram showing a system according to the invention as a whole.

FIG. 2 is a block diagram of a transmission-related principal portion of an AV data transmitting apparatus.

FIG. 3 is a conceptual diagram of a packet sequence.

FIG. 4 is a conceptual diagram of a packet sequence in another embodiment.

FIG. 5 is a diagram showing an image quality setting switch.

FIG. 6 is a block diagram of a transmission-related principal portion of an AV data transmitting apparatus in another embodiment.

FIG. 7 is a diagram showing a channel switch.

FIG. 8 a block diagram of a transmission-related principal portion of an AV data transmitting apparatus in another embodiment.

FIG. 9 is a flow chart showing how the AV data transmitting apparatus shown in FIG. 8 transfers a control command to an AV data output apparatus.

FIG. 10 is another flow chart showing how the AV data transmitting apparatus transfers a control command to an AV data output apparatus.

FIG. 11 is a diagram showing an example of how the AV data transmitting apparatus is implemented.

FIG. 12 is a block diagram of an AV data receiving apparatus.

FIG. 13 is a diagram showing an AV data receiving apparatus and a photoreceiver.

FIG. 14 is a diagram showing how an AV data receiving apparatus is fitted on a rear face of a liquid crystal television monitor.

FIG. 15 is a diagram showing how an AV data receiving apparatus is fitted on a rear face of a display apparatus in another embodiment.

FIG. 16 is a diagram showing an outline of an AV data receiving apparatus.

FIG. 17 is a diagram showing an embodiment in which an infrared photoreceiver and an antenna are integrated together.

FIG. 18 is a diagram illustrating how an AV data receiving apparatus is connected to a display apparatus.

FIG. 19 is a diagram showing an AV data receiving apparatus connected to a display apparatus.

FIG. 20 is a diagram illustrating how an AV data receiving apparatus is connected to a battery.

FIG. 21 is a diagram showing an AV data receiving apparatus connected to a battery.

FIG. 22 is a diagram illustrating connection of an AV data receiving apparatus having a battery fitted thereto.

FIG. 23 is a diagram illustrating how an AV data receiving apparatus having a battery fitted thereto is connected to a display apparatus.

FIG. 24 is a block diagram of an apparatus that transmits AV data and IP data simultaneously.

FIG. 25 is a diagram showing the packet format conforming to IEEE802.2.

FIG. 26 is a diagram illustrating the relationship between an AV data receiving apparatus, an AV data transmitting apparatus, an IP data transmitting/receiving apparatus, and a network.

### BEST MODE FOR CARRYING OUT THE INVENTION

Hereinafter, an example of embodiment of the present invention will be described in detail with reference to the drawings.

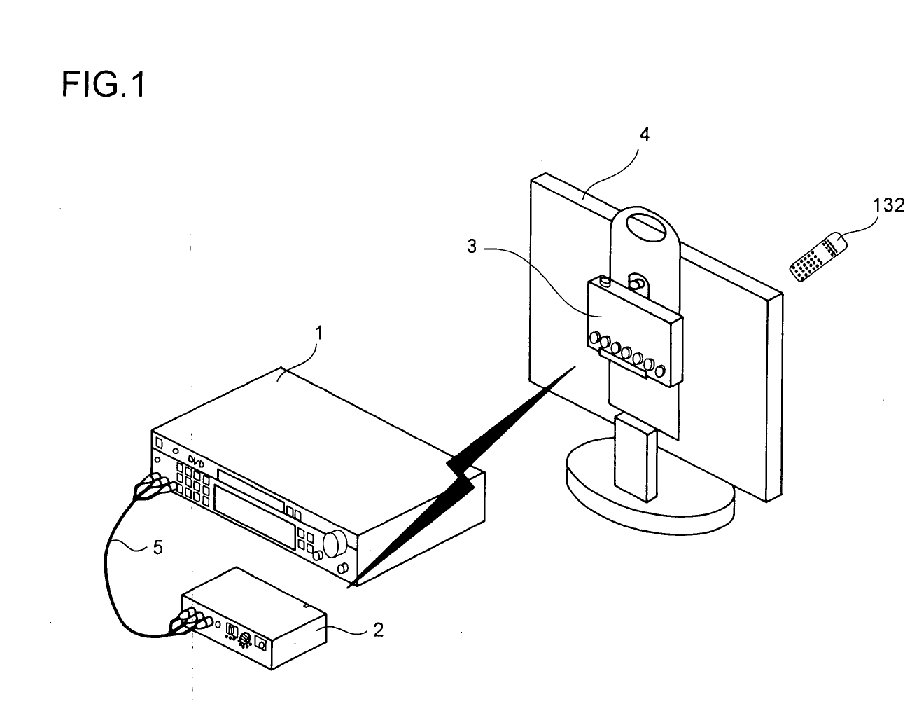

FIG. 1 is a diagram showing a system as a whole according to the present invention. Reference numeral 1 represents an AV data output apparatus such as a videocassette recorder, DVD player, tuner, stereo set, or personal computer; reference numeral 2 represents an AV data transmitting apparatus; reference numeral 3 represents an AV data receiving apparatus; reference numeral 4 represents an AV data displaying/reproducing apparatus such as a flat display like a liquid crystal television monitor, any other type of monitor, or personal computer; reference numeral 132 represents an infrared remote control transmitter. In the figure, the AV data output apparatus 1 and the AV data transmitting apparatus 2 are connected together with a cable 5, and likewise the AV data receiving apparatus 3 and the AV data displaying/reproducing apparatus 4 are connected together with a cable (not shown). These units, however, may be connected together in any other manner. For example, the AV data transmitting apparatus 2 or the AV data receiving apparatus 3 may be built in the form of a PCI board or a PCMCIA card so as to be connected via a PCI bus or the like. The AV data transmitting apparatus 2 and the AV data receiving apparatus 3 exchange AV data and asynchronous data by the use of a radio wave. The remote control transmitter 132 may use a radio wave; the AV data transmitting apparatus 2 and the AV data receiving apparatus 3 may exchange data by the use of infrared light.

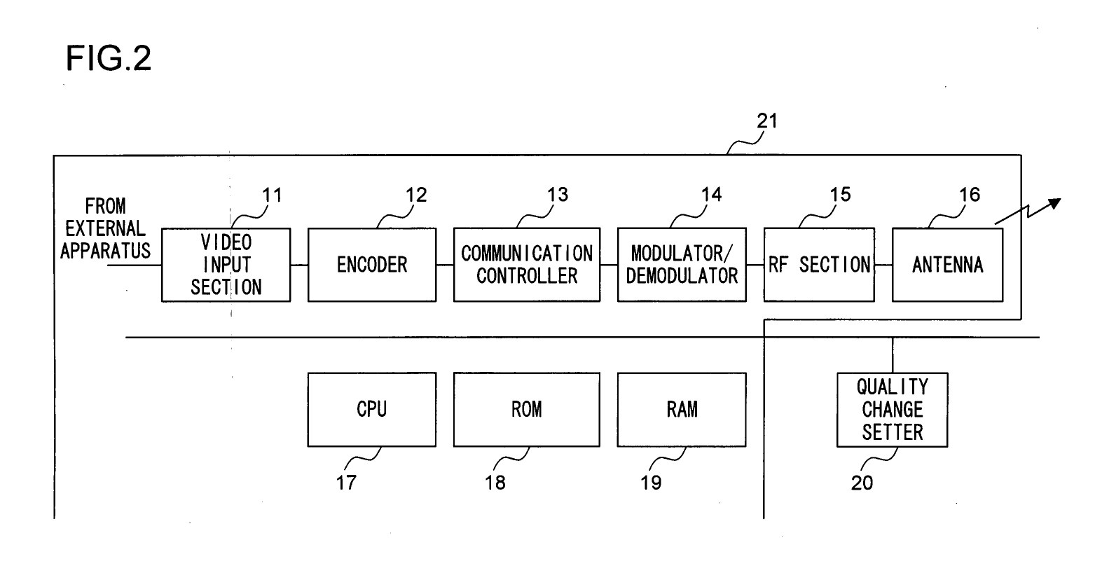

FIG. 2 is a block diagram showing a transmission-related principal portion 21 of the AV data transmitting apparatus 2 which is so configured as to be able to change the quality of AV data. Reference numeral 11 represents a video input section to which AV data such as images (still and moving pictures), music, and sounds are fed from an external apparatus such as the AV data output apparatus 1. Reference numeral 12 represents an encoder that compresses the AV data fed to the video input section 11. In a case where AV data, namely images, music, and sounds, are transferred simultaneously, this encoder 12 typically uses the MPEG-2 format, in particular its TS (transport stream), which has a constant bit rate. The encoder 12, however, may use any other format. The encoder 12 may even simply have a capability of converting the bit rate or format of already encoded data.

Reference numeral 13 represents a communication controller that controls communication to transmit AV data and to transmit and receive control commands and asynchronous data. The communication controller 13 uses, for example, a communication control method based on a TDMA (time domain multiple duplex) technology, whereby transmission and reception is controlled separately on a time-division basis, or a CSMA/CA (carrier sense multiple access/collision avoidance) technology, whereby whether data is flowing via a wireless route or not is checked so that communication is started when no data is flowing there. The communication controller 13, however, may use any other communication control method. Reference numeral 14 represents a modulator/demodulator that modulates and demodulates AV data. Wireless communication is achieved by the use of a radio wave in the 2.4 GHz, 5 GHz, 25 GHz, 60 GHz, or any other frequency band. Here, which frequency band the radio wave is in does not matter. Reference numeral 15 represents an RF section that performs up-conversion to the wireless frequency and down-conversion from the wireless frequency to the frequency that can be dealt with by digital circuitry. The RF section 15 includes an amplifier circuit and other circuits peculiar to wireless circuitry. Reference numeral 16 represents an output section that actually performs wireless transmission and reception, which is realized with an antenna when a radio wave is used. Reference numeral 17 represents a CPU that performs overall control. Reference numeral 18 represents a ROM in which programs and tables used by the CPU are stored. Reference numeral 19 represents a RAM that is used as a working area by the CPU. Depending on actual implementation, the RAM 19 may be used by the encoder or by the communication controller.

Reference numeral 20 represents a quality change setter that permits the user to set a change in the quality of AV data. The quality is selectable among, for example, three grades, namely high, medium, and low quality. The user selects one of these according to the condition at the moment. When the quality is set, the information is read by the CPU 17, which then feeds the result to the encoder 12 and, if necessary, also to the communication controller 13. For example, when the quality is changed from high to low, the amount of data output from the encoder 12 is reduced (for example, from 7 Mpbs to 4 Mbps). As a result, the bandwidth used for communication is accordingly reduced, freeing a 3 Mbps bandwidth for use by another application (for example, for communication over the Internet).

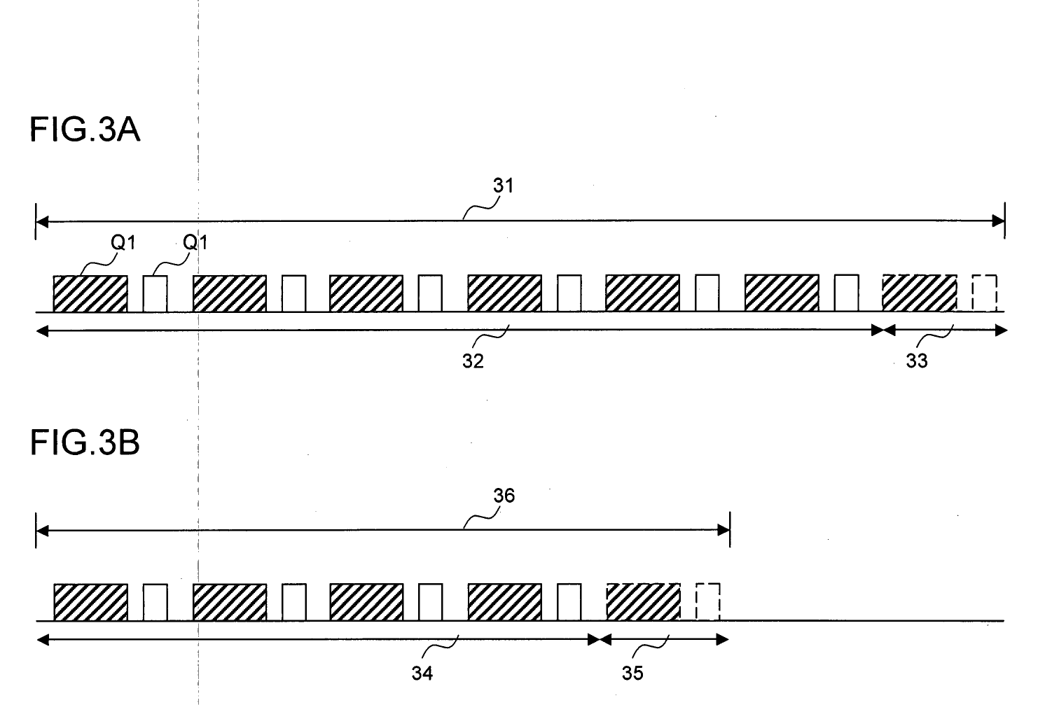

Now, as an example of implementation, a description will be given of a case where the user changes the AV data quality and thereby changes the communication bandwidth. When a change in the quality is set in the quality change setter 20 shown in FIG. 2, the setting is read by the CPU 17, which then sets a new data rate in the encoder 12 and the communication controller 13. Here, the communication controller 13, according to the change in the data rate, changes the communication bandwidth. FIG. 3 is a conceptual diagram of a packet sequence. In this figure, the lapse of time is taken along the horizontal axis. In FIG. 3, at (a) is shown an example with high image quality (high data quality), and at (b) is shown an example with medium image quality (medium data quality). Reference numeral 31 represents a total AV data transmission period for transmitting AV data. This period occurs every predetermined length of time that depends on the AV data rate. Reference numeral 32 represents a main AV data transmission period for transmitting AV data. Unless an error occurs, image data can be transmitted by the use of all the main AV data transmission period 32. The hatched rectangulars Q1 represent packets of AV data, and the blank rectangulars Q2 represent Ack packets, which are sent for acknowledgment of recept. Using Ack packets for acknowledgment of recept is a mere example, and Nack packets may be used instead, which indicate failure of receipt.

Reference numeral 33 represents an AV data resend period for resending AV data. If an error occurs during the main AV data transmission period 32, AV data is resent during the AV data resend period 33. In the example being described, even when one among six packets contains an error, by resending the one packet containing the error, it is possible to avoid disturbance in the image. In the example with medium image quality shown at (b) in FIG. 3, a smaller bandwidth is used by transmitting ordinary AV data in four packets during a total AV data transmission period 36 for medium image quality. An AV data resend period 35 for medium image quality covers one packet. That is, by lowering the quality of AV data, it is possible to reduce the amount of data and thereby increase the wireless bandwidth for other communication. In the example being described, switching from the total AV data transmission period 31 to the total AV data transmission period 36 for medium image quality results in reducing the amount of transmitted data, and thus results in accordingly increasing the bandwidth for other communication. In this example, it is assumed that resending takes place; however, the same description applies even when no resending takes place. Although not illustrated, a total AV data transmission period for low image quality (low data quality) covers three packets, of which two are covered by a main AV data transmission period and of which one is covered by an AV data resend period.

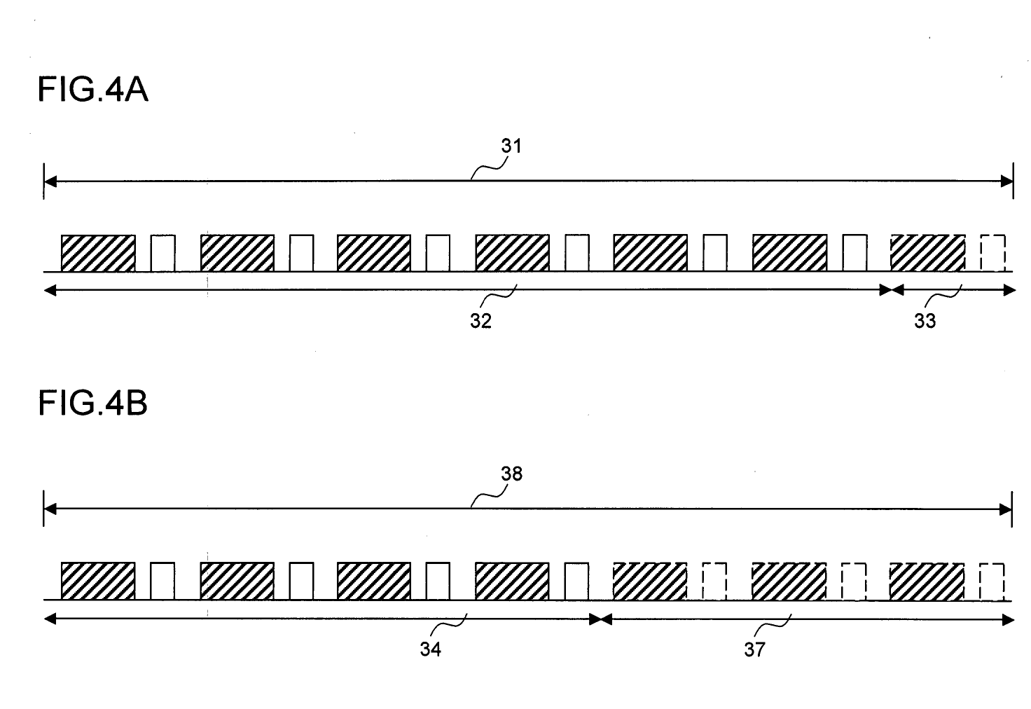

Next, as another embodiment, a description will be given of a case where, at the same time that the AV data quality is changed, the reliability of communication is also changed. FIG. 4 is a conceptual diagram of a packet sequence observed in this case. In FIG. 4, at (a) is shown an example of transfer of high-quality AV data, and at (b) is shown an example of transfer of medium-quality AV data. In these examples, while the AV data resend period 33 permits resending only once, the AV data resend period 37 for medium image quality permits resending three times. In this case, even if up to three among the frames covered by the AV data transmission period 34 for medium image quality (which covers four frames) contain an error, the errors can be corrected.

In this embodiment, the total AV data transmission period 31 and the total AV data transmission period 38 are made equally long. Although not illustrated, an AV data resend period for low quality is so set as to permit resending four or five times. In this way, while the AV data quality is lowered, the incidence of errors is rapidly reduced as resending is permitted an increased number of times. Incidentally, the bandwidth may be controlled, instead of by controlling the number of packets as in these examples, by controlling the length of packets, or by any other method.

On the other hand, the reliability of communication may be changed, instead of by changing the number of times that resending is permitted, by adding or removing error correction codes. By changing the AV data quality and simultaneously changing the reliability in this way, even if errors occur during the communication period, it is possible to switch the AV data quality to a lower setting and thereby reduce communication errors. A change in the quality is set in the quality change setter 20 by the user operating the quality change setter 20. Alternatively, such a change may be set on the AV data receiving apparatus or on the AV data displaying/reproducing apparatus and the corresponding change command transmitted via a wireless route to the transmitting apparatus so that the change is set in the quality change setter 20 of the transmitting apparatus.

In a case where, with respect to a change in the bandwidth or in the number of times of resending, a setting in the receiving apparatus needs to be changed, a command for such a change in the bandwidth or in the number of times of resending may be transmitted from the transmitting apparatus to the receiving apparatus so as to change the setting in the receiving apparatus. The different grades of quality are set in the following manner. The IEEE802.11b standard permits a maximum of 11 Mbps as a rate on a wireless route. In a case where MPEG-2 TS video or music is transmitted at this rate, it is advisable to set the high image quality (high data quality) at about 7 Mbps, the medium image quality (medium data quality) at about 5 Mbps, and the low image quality (low data quality) at about 4 Mbps. With the IEEE802.11a standard, which permits a maximum of 54 Mbps as a rate on a wireless route, to handle MPEG-2 video, it is preferable to increase the above AV data transmission rate by about 24 Mbps and 12 Mpbs.

An example of the means for setting a change in the AV data quality according to the present invention is by realizing the quality change setter 20 with a switch. The user usually changes the AV data quality according to the communication condition while, for example, watching a movie. In such a case, it is undesirable to show the operation of making a change on the screen or indicate an image quality setting or the like on the screen being displayed. Instead, it is preferable to use a rotary switch, slide switch, or the like, because it permits the current AV data quality setting to be recognized at a glance and permits the image quality to be set elsewhere than on the screen. This permits easier setting of the image quality.

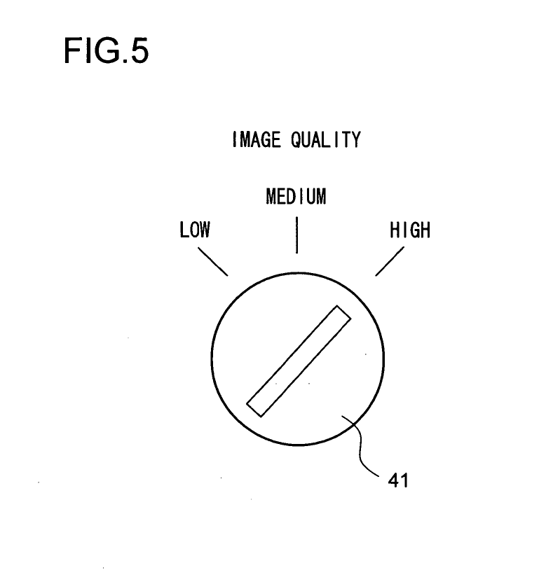

This quality setting switch may be provided in the AV data receiving apparatus so that a setting is transmitted as a control command wirelessly to the transmitting apparatus to make the quality change setter 20 of the transmitting apparatus set the AV data quality. FIG. 5 shows the quality setting switch 41. In this example, the image quality is selectable among high, medium, and low quality.

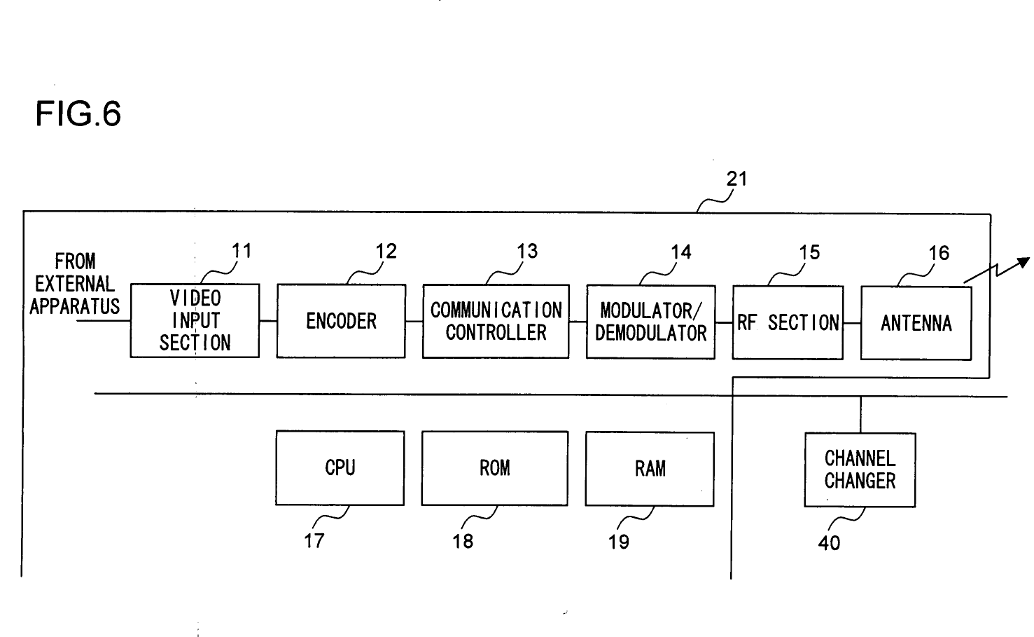

As another embodiment of the present invention, FIG. 6 shows a block diagram showing a case where the wireless channel is changed. Reference numeral 21 represents the same transmission-related principal portion 21 as the one used in the AV data transmitting apparatus shown in FIG. 2, and therefore its explanations will not be repeated. Reference numeral 40 represents a channel changer that changes the wireless channel. When a change is made in the setting of the channel changer, the information is read by the CPU 17, and the communication controller 13 is set for a new channel. Usually, a wireless system involves a plurality of channels that can be used simultaneously. The EEEE802.11b technology, which permits data transfer at 11 Mbps in the 2.4 GHz band, permits simultaneous use of three channels each having a 11 Mbps bandwidth, and permits selection of one among those three channels. The three channels offer different communication error rates depending on the condition of the apparatuses that are placed nearby and are radiating radio waves. By switching channels, it is possible to select a channel that offer a lower error rate.

According to the present invention, since the channel is switched with the switch, the user does not need to check the current setting as by switching indications on the screen. That is, the user can confirm the currently set channel simply by visually checking the position in which the switch is currently in, and can change the setting without displaying an indication or the like on the screen. As another method for selecting a channel, it is also possible to previously prepare statistic information on communication quality (for example, information on the error rates on each channel that vary according to the month, day of the week, and hour) and switch the channel automatically within the transmitting apparatus on the basis of the information.

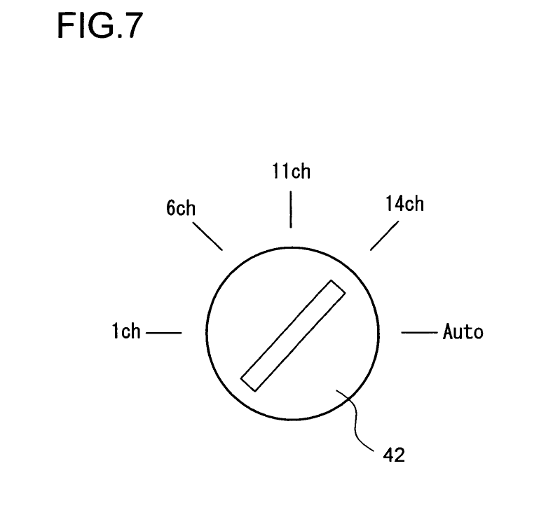

FIG. 7 shows the switch 42 for changing the channel. In this example, a rotary switch is used that permits selection among individual channels, namely 1ch, 6ch, 11ch, and 14ch, and an automatic mode in which the channel is automatically changed among 1ch, 6ch, and 11ch periodically. This switch may be provided in the AV data receiving apparatus 3 or in the AV data displaying/reproducing apparatus 4 so that the result set with the switch is sent as a control command wirelessly to the AV data transmitting apparatus 2 to make the channel changer of the AV data transmitting apparatus 2 operate. How the AV data receiving apparatus 3 reflects a change of the channel set on the AV data transmitting apparatus 2 may be switched by transmitting a channel change command from the AV data transmitting apparatus 2 to the AV data receiving apparatus 3. Alternatively, when the transmission channel is changed, the AV data receiving apparatus may automatically detect a channel on which AV data is flowing and automatically change channels.

As another embodiment of the present invention for changing the wireless channel, in particular in a case where the 2.4 GHz band (2 400 MHz to 2 497 MHz) is used, a part of the band above the 13th channel (with a central frequency of 2 472 MHz) is made usable (the band can thus be called the 14th channel). The 2.4 GHz band is used by the Bluetooth technology, which performs communication while going around a wide band in a short time. The Bluetooth technology performs communication while changing frequencies at a maximum rate of 1 600 times per second through the 1st to 13th channels, and thus increases noise on the 1st to 13th channels for wireless systems other than the Bluetooth technology. Thus, the part of the band above the 13th channel is less affected by the noise of the Bluetooth technology. Accordingly, by making that part of the band usable, it is possible to select a channel that offers less communication errors. Needless to say, a change to that channel may be achieved with a switch, or by the use of a remote control transmitter, or by displaying an indication on a channel change screen.

With respect to a change in the communication reliability (the number of times of resending) that accompanies a change in the AV data quality, checking may be performed automatically. If the AV data transmitting side adds error correction codes (for example, Reed-Solomon codes) to transmitted packets, the AV data receiving apparatus can not only correct errors but also obtain the number of corrected bytes. In addition, it is also possible to recognize a block (a unit of bytes, typically about 200 bytes, to which a Reed-Solomon code is applied) for which error correction has failed. Moreover, the AV data receiving apparatus 3 can recognize missing packets on the basis of the sequence numbers and time information added by the transmitting side, and thus on the basis of the sequence numbers and time information of received packets (if packets with sequence numbers 5, 6, 7, and 9 are received, a packet with sequence number 8 is recognized to be missing). By the use of such information, the AV data receiving apparatus 3 can guess the incidence of errors on the currently selected channel, and thus, on the basis of the information, the AV data receiving apparatus 3 can transmit a command for changing the AV data quality or for changing the channel to the AV data transmitting apparatus 2 to effect the change.

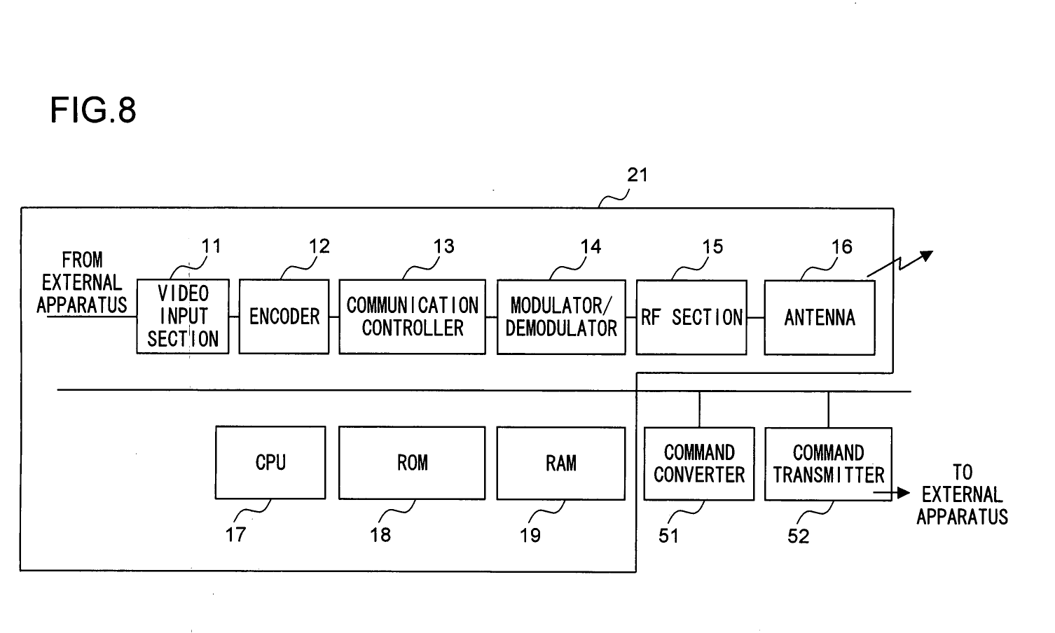

FIG. 8 is a block diagram of a transmission-related principal portion of an AV data transmitting apparatus according to the present invention which is so configured as to receive a control command via a wireless route and then transmit the control command to an external apparatus by the use of, for example, infrared light. Reference numeral 21 represents the same transmission-related principal portion 21 as the one used in the AV data transmitting apparatus shown in FIG. 2, and therefore its explanations will not be repeated. Reference numeral 51 represents a command converter that converts a control command received via a wireless route to a format that suits an external apparatus. Reference numeral 52 represents an IR command transmitter that transmits a control command (for example, a control signal in the form of infrared light) to an external apparatus such as an AV data receiving apparatus (for example, a displaying apparatus). The IR command transmitter 52 is composed of, for example, an LED and a photodiode.

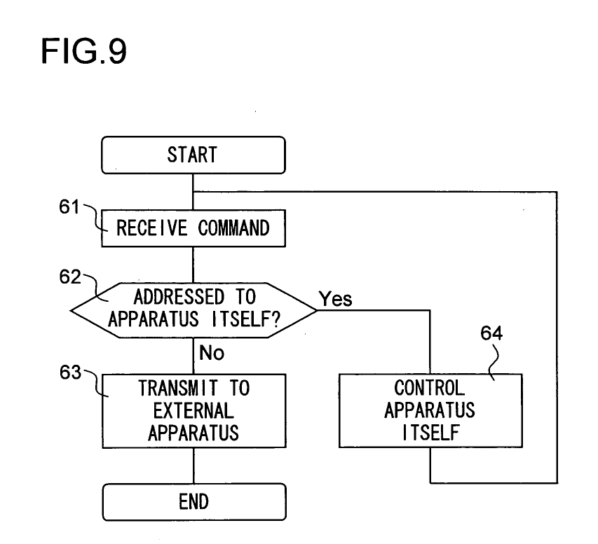

FIG. 9 is a flow chart of the operations that the AV data transmitting apparatus 2 shown in FIG. 8 performs to forward a control command transmitted wirelessly from the AV data receiving apparatus 3 to an external AV data output apparatus 1. Reference numeral 61 represents a step of receiving a control command transmitted as asynchronous data from the AV data receiving apparatus 3. Reference numeral 62 represents a step of checking whether or not the command is addressed to the transmitting apparatus itself. The command, if addressed to the transmitting apparatus itself, is, for example, one requesting a change in the transmission frequency or in the image quality. Whether or not the command is addressed to the transmitting apparatus itself is checked on the basis of an identification code that the command contains. In step 63, a control command that is not addressed to the transmitting apparatus itself is transmitted, through the IR command transmitter, to the external AV data output apparatus such as a videocassette recorder to control it. The control command, if addressed to a video cassette recorder, is, for example, one requesting fast forwarding, rewinding, stopping, or the like. In step 64, the transmitting apparatus itself is controlled according to the control command addressed thereto. The control command, if addressed to the transmitting apparatus itself, is, for example, one requesting a change in the AV data quality or in the wireless channel or one requesting starting or ending of AV data transmission, i.e., one according which the encoder, communication controller, modulator/demodulator, and RF section are controlled.

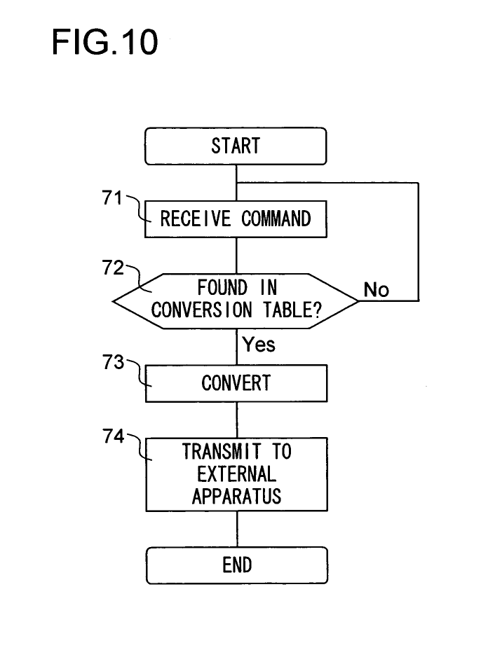

FIG. 10 is another flow chart of the operations that the AV data transmitting apparatus 2 performs to forward a control command transmitted wirelessly from the AV data receiving apparatus 3 to the AV data output apparatus 1. Reference numeral 71 represents a step, like step 61, of receiving a command transmitted via a wireless route. Reference numeral 72 represents a step of referring to a conversion table stored in the ROM 18 or RAM 19 to check whether or not the command currently being processed is found in the conversion table. Reference numeral 73 represents a step of, if the command is found in the conversion table, converting the command. Reference numeral 74 represents a step of transmitting the converted command to the external apparatus, i.e., the AV data output apparatus 1, by the use of, for example, infrared light. In this example, a command that is not found in the conversion table is ignored. Alternatively, a command that is not found in the conversion table may be transmitted without conversion, or a table other than a conversion table may be used with reference to which to determine whether or not to transmit such a command.

With the present invention, it is possible, for example, to convert a command received via a wireless route and requesting “video playback” into an infrared command requesting “video playback on an ‘S Corporation’-made videocassette recorder,” or to prohibit a command received via a wireless route and requesting “higher sound volume” on a television monitor from being transmitted to an external apparatus. For example, when the user operates a remote control transmitter on an AV data receiving apparatus, the command is sent to an AV data transmitting apparatus via a wireless route. In such a case, the user most probably wants to operate the volume of a television monitor located in front of him or her, and not of a television monitor located near an AV data transmitting apparatus that may be installed in another room.

In such a case, according to the present invention, with a conversion table so prepared that commands for controlling a television monitor are not transmitted to an external terminal, the AV data transmitting apparatus does not issue any command for controlling a television monitor. This helps prevent a television monitor located near the AV data transmitting apparatus from being erroneously controlled.

In another embodiment of the present invention, the command conversion table (conversion rules) provided in the command converter is made rewritable so that it can be changed from outside. By changing the command conversion table, it is possible to switch from a rule according to which a command received via a wireless route and requesting “video playback” is converted into an infrared command requesting “video playback on an ‘S Corporation’-made videocassette recorder” to a rule according to which the command requesting “video playback” is converted into a command requesting “video playback on a ‘P Corporation’-made DVD player.” The present invention permits the user to issue control commands that suit the AV data output apparatus that he or she possesses.

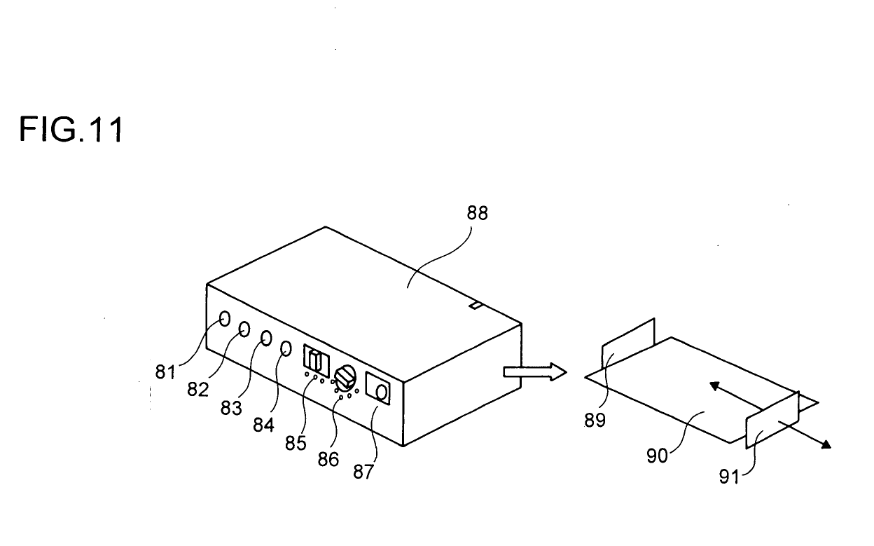

FIG. 11 shows an example of implementation of the AV data transmitting apparatus. In the figure, reference numeral 81 represents a factory shipment terminal. Via this terminal 81, the contents of the ROM can be changed, and internal diagnosis can be performed. Reference numeral 82 represents an AV output terminal. Reference numeral 83 represents an AV input terminal. AV data is fed in via the AV input terminal 83, is then encoded within the AV data transmitting apparatus, and is then transmitted to the AV data receiving apparatus. Simultaneously, the same AV data is output via the AV output terminal 82. This is because the AV data transmitting apparatus is supposed to be connected, for example, between a videocassette recorder and a television mentor. In that case, the output from the AV output terminal 82 is coupled to the television monitor located near the videocassette recorder. In that case, it is preferable that the signal fed to the AV input terminal 83 be kept appearing at the AV output terminal 82 all the time even when the AV data transmitting apparatus is not turned on.

Reference numeral 84 represents a terminal to which an infrared light emitter is connected. This is to convert a wirelessly transmitted control command into an infrared command, then make the infrared light emitter connected to the terminal blink, and thereby control an apparatus (for example, a videocassette recorder) located in front of it. Reference numeral 85 represents an image quality switch. Reference numeral 86 represents a communication channel switch. Reference numeral 87 represents a power input terminal. Reference numeral 88 represents the casing of the AV data transmitting apparatus. Reference numerals 89 and 91 represent flat antennas that are fixed inside the casing, and reference numeral 90 represents a circuit board. This is illustrated at the same angle as the casing. The two flat antennas 89 and 91 are for diversity reception. It is, however, not absolutely necessary to provide two of them; there may be provided more than two antennas.

The circuit board 90 is covered with a conductive material, and thus shields radio waves. For this reason, the antennas are arranged at a substantially right angle to the surface of the circuit board so that the circuit board 90 does not obstruct the direction in which the antennas exhibit the maximum signal strength. Specifically, the flat antennas 89 and 91 illustrated are so arranged that the direction in which the radio wave travels, i.e., the direction indicated by arrows, is not obstructed by the circuit board. Likewise, the faces on which switches and connectors are arranged contain much conductive material, and therefore the antennas are so arranged that the direction indicated by arrows is not obstructed by those faces either. With respect to the arrangement of an antenna, the same principles apply with the AV data receiving apparatus; that is, it is preferable that an antenna be so arranged that the direction in which the antenna is effective is not obstructed by a circuit board, connector, or switch.

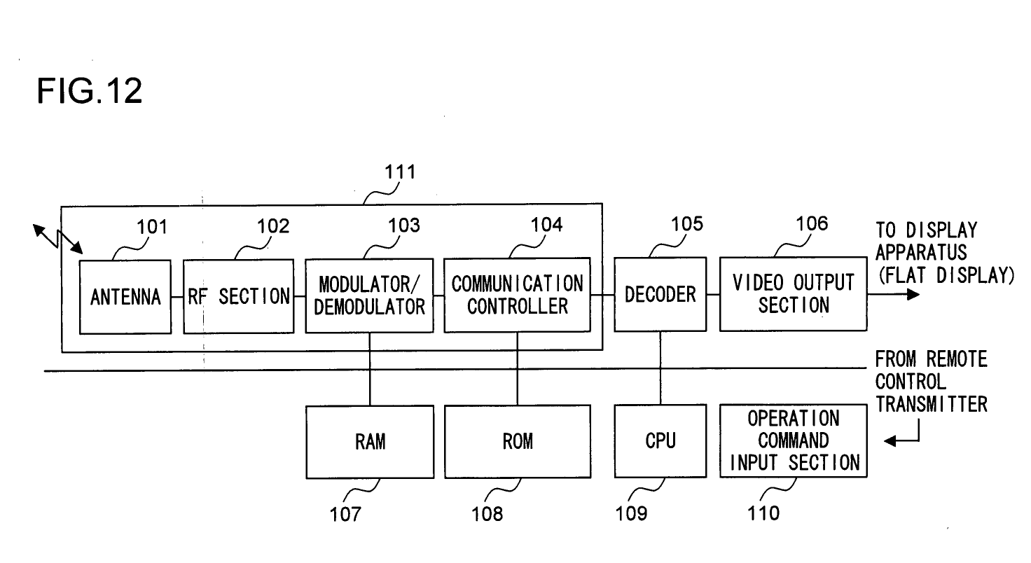

FIG. 12 shows an example of a block diagram of the AV data receiving apparatus according to the present inventions. Reference numeral 101 represents an antenna that actually transmits and receives a radio wave. Reference numeral 102 represents an RF section that performs up-conversion to the wireless frequency and down-conversion from the wireless frequency to the frequency that can be dealt with by digital circuitry. The RF section 102 includes an amplifier circuit and other circuits peculiar to wireless circuitry. Reference numeral 103 represents a modulator/demodulator that modulates and demodulates data. Reference numeral 104 represents a communication controller that controls communication to transmit AV data and to transmit and receive control commands and asynchronous data. The blocks 101 to 104 together constitute a wireless communication section 111. Reference numeral 105 represents an encoder that decompresses the AV data fed thereto from the communication controller 104. Reference numeral 106 represents a video output section that achieves connection to an unillustrated AV data displaying/reproducing apparatus, which may be an external apparatus, such as a display unit, image recording unit, or flat display such as a liquid crystal television monitor. Reference numeral 107 represents a RAM that is used as a working area by a CPU. Reference numeral 108 represents a ROM in which programs and tables used by the CPU are stored. Reference numeral 109 represents a CPU that performs overall control. Reference numeral 110 represents an IR command input section that receives optical operation commands sent from an external apparatus and from a remote control transmitter.

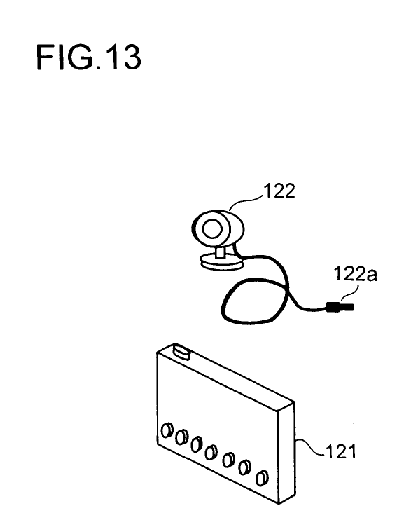

FIG. 13 shows an example of implementation of the AV data receiving apparatus according to the present invention. Reference numeral 121 represents the main unit of the AV data receiving apparatus, and reference numeral 122 represents an external infrared receiver that is movable. The external infrared receiver 122 has, at the other end of its connection line, a plug 122a, which is inserted into a connector (not illustrated) provided in the main unit of the AV data receiving apparatus.

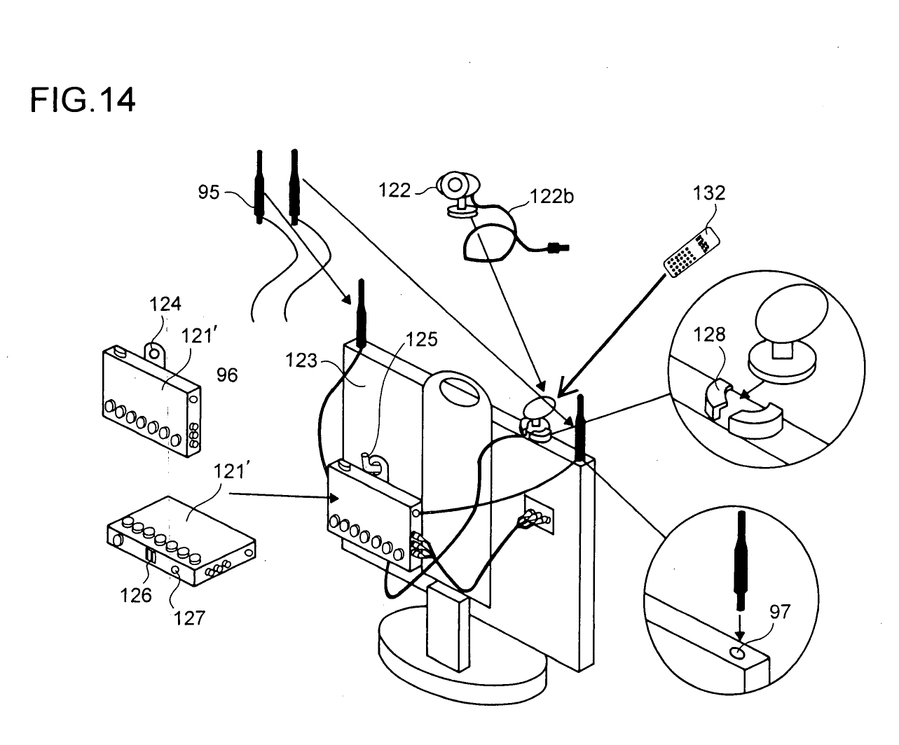

FIG. 14 is a diagram showing how the main unit of the AV data receiving apparatus is fitted on the rear face of a display apparatus with a flat display, such as a liquid crystal television monitor. Reference numeral 123 represents a display apparatus built as a liquid crystal display monitor, and reference numeral 132 represents an infrared remote control transmitter. The fitting of the AV data receiving apparatus 121′ is achieved by inserting a hook 125 provided on the rear face of the liquid crystal television monitor into a fitting hole 124. The fitting hole 124 and the hook 125 may be replaced with any other fitting mechanism. Here, the AV data receiving apparatus 121′ is fitted on the rear face of the display apparatus 123, and thus cannot directly receive infrared commands from the remote control transmitter 132. However, by permitting the infrared receiver 122 to be moved to a position visible from the user as shown in the figure, it is possible to permit the AV data receiving apparatus 121′ to receive commands from the remote control transmitter 132. The cable 122b of the external infrared receiver 122 is made 20 cm to 80 cm long so that the AV data receiving apparatus 121′ fitted on the rear face of the display apparatus 123 can be connected to the external infrared receiver terminal 127.

When the AV data receiving apparatus 121′ and the display apparatus 123 are connected together on a wired basis, and the infrared command signals received by the infrared receiver 122 are not only processed within the display apparatus 123 but also sent intact to the AV data receiving apparatus 121′, it is possible, without separately providing an external infrared receiver, to receive remote control commands from the remote control transmitter operated by the user present in front of the display apparatus 123 and transmit them to the AV data transmitting apparatus.

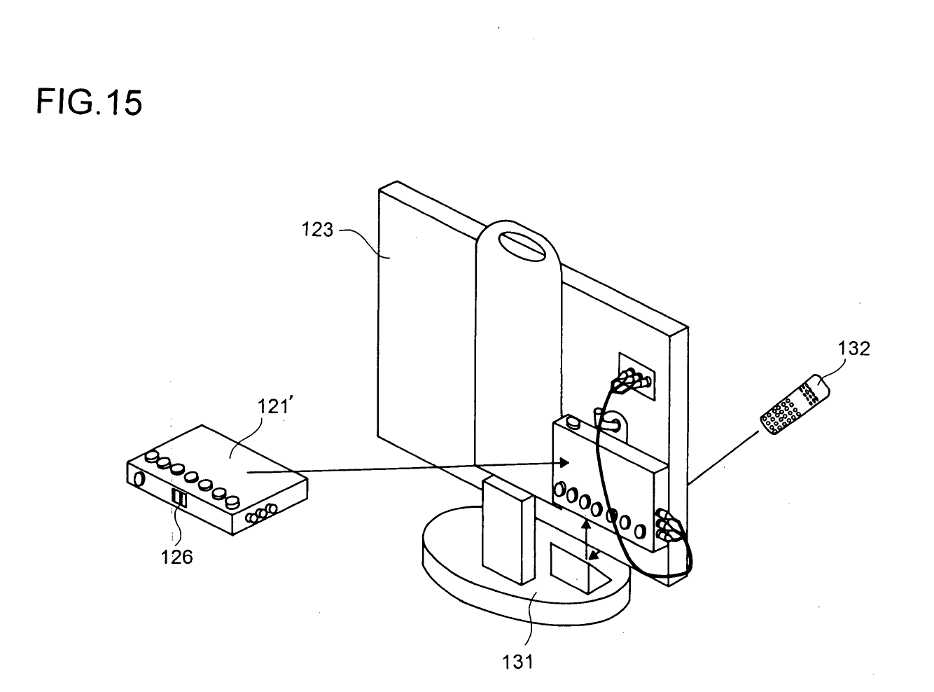

FIG. 15 shows another embodiment in which the AV data receiving apparatus according to the present invention is fitted on the rear face of a display apparatus. Reference numeral 131 represents a reflective mirror that reflects infrared light. When the AV data receiving apparatus 121′ is fitted on the rear face of the display apparatus 123, it cannot directly receive the infrared light from the front face of the display apparatus. However, by providing the reflective mirror 131, it is possible to make the infrared light reach the AV data receiving apparatus main unit infrared receiver 126 fitted on the rear face of the display apparatus 123. This makes possible direct control from in front of the display apparatus 123by the use of the remote control transmitter 132.

Back in FIG. 14, the display apparatus 123 has a holding mechanism, for removably holding the external infrared receiver 122, provided on the top face of the AV data displaying/reproducing apparatus (display apparatus) 123. This permits the user to easily and securely fit and remove the external infrared receiver to and from the AV data displaying/reproducing apparatus (display apparatus) 123.

As another embodiment, a description will be given of a case where the AV data receiving apparatus or the AV data transmitting apparatus is fitted with an antenna interface. When a high-performance external antenna is externally fitted to the apparatus, it is possible to perform communication over a wider range. In a case where both the AV data transmitting apparatus and the AV data receiving apparatus are used in fixed positions, by using external antennas with high directionality and properly adjusting their orientation, it is possible to transfer AV data even between remote rooms in a bigger house. On the other hand, in a case where radio waves do not reach far enough because of the presence of concrete walls or the like as in a reinforced concrete building or the like, by replacing the antennas with ones that offer a higher gain, it is possible to realize a high-performance AV data communication system (the combination shown in FIG. 1). The antenna interface then serves to disable the antenna 101 shown in FIG. 12 and enable an external antenna.

In FIG. 14, reference numeral 95 represents external antennas; reference numeral 96 represents external antenna connection terminals; and reference numeral 97 represents external antenna fitting portions provided in the display apparatus 123. This construction helps easily obtain reception performance that suits the radio wave condition at the user's site. The external antenna 95 may be provided on the AV data receiving apparatus 121′. The external antenna 95 may be placed separately away from the display apparatus 123 by the use of a stand or the like.

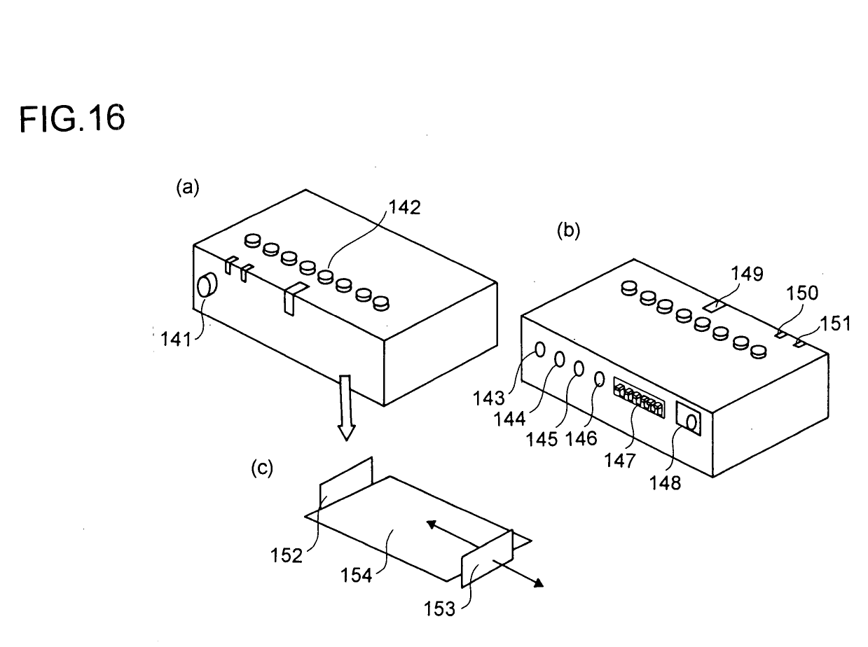

FIG. 16 shows an outline of the AV data receiving apparatus according to the present invention. FIG. 16(a) is a front outline view of the AV data receiving apparatus, FIG. 16(b) is a rear outline view thereof, and FIG. 16(c) is a diagram showing the circuit board and the antenna housed inside the AV data receiving apparatus. Reference numeral 141 represents a power button. Reference numeral 142 represents control buttons provided on the AV data receiving apparatus. These buttons correspond to, for example, power, input select, tune (forward and backward), rewind, fast forward, playback, stop, and other buttons. Reference numeral 143 represents a factory adjustment terminal that is used to rewrite the ROM, to perform self checks, and to monitor errors during reception.

Reference numeral 144 represents an AV output terminal, which is connected to the AV data displaying/reproducing apparatus. Reference numeral 145 represents an infrared receiver connection terminal, to which an externally fitted infrared receiver is connected. Reference numeral 146 represents an external antenna connection terminal. Reference numeral 147 represents a video controller setting switch. Reference numeral 148 represents a power connector, and reference numeral 149 represents an infrared receiver. Reference numeral 150 represents a reception level lamp, which is lit green when reception is normal and red when reception is abnormal. Whether reception is abnormal or not is checked, for example, by guessing the incidence of errors by counting, on the receiving side, the number of corrected errors on the basis of error correction codes (for example, Reed-Solomon codes) or the number of erroneous and thus resent packets. The reception level lamp 150 may be kept off when no AV data communication is taking place. Reference numeral 151 represents a power lamp, which is lit when the power is on.

Reference numerals 152, 153, and 154 show the circuit board and the antennas housed inside the casing of the AV data receiving apparatus. Reference numerals 152 and 153 represent antennas, and reference numeral 154 represents a circuit board. The antenna 153 is so arranged as to exhibit its maximum sensitivity in the direction indicated by arrows. As shown in FIG. 16, the infrared receiver connection terminal 145 and the external antenna connection terminal 146 are arranged in the vicinity of each other on the same face. This makes it easy to externally fit the two externally fitted units, namely the external antennas 95 and the external infrared receiver 122.

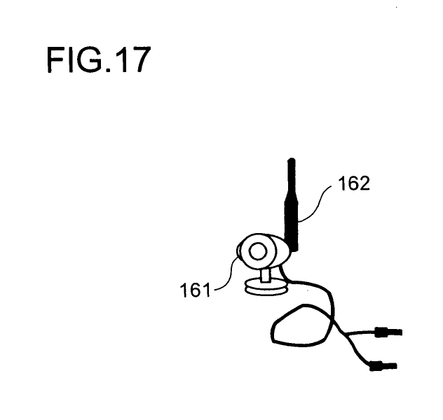

FIG. 17 shows a structure in which an infrared receiver 161 and an external antenna 162 are integrated together. This permits the infrared receiver and the antenna to be fixed at the same time.

The switches 142 shown in FIG. 16 produce commands for controlling the AV data output apparatus connected on the AV data transmitting apparatus side. These commands are wirelessly transmitted to the AV data transmitting apparatus, which then converts them into control commands for the AV data output apparatus, which is an external apparatus, and then forwards them to the AV data output apparatus. These commands may be the same as those transmitted from the infrared remote control transmitter. Providing the switches 142 on the AV data receiving apparatus permits the user to control the functions of the AV data output apparatus by operating the switches 142 without carrying around the remote control transmitter.

The commands from the switches 142 and the control data from the remote control transmitter 132 may be interpreted within the apparatus so that, as necessary, the commands are converted or checks are made as to whether to forward the commands or not. This makes more flexible control of the image output apparatus possible. In that case, the control flows are basically the same as those shown in FIGS. 9 and 10, except that, in step 61 in FIG. 9 and in step 71 in FIG. 10, commands are received in the form of infrared light and, in step 63 in FIG. 9 and in step 74 in FIG. 10, commands are transmitted wirelessly.

It is preferable that the table used to convert commands or to make checks as to whether to forward them or not be settable from outside. Then, by changing the table, the user can set the commands output to the image output apparatus to those appropriate for the type and manufacturer of the output apparatus. When a conversion table is used, a command is converted by the following procedure:

1. The remote control transmitter transmits a general command requesting “playback”.

2. In the AV data receiving apparatus, there is stored a conversion table for an ‘S-Corporation’-made videocassette recorder as an image output apparatus.

3. The “playback” command received in the form of infrared light is converted into a command requesting “playback on an ‘S-Corporation’-made videocassette recorder,” and is then wirelessly sent to the AV data transmitting apparatus.

4. The AV data transmitting apparatus sends out the command requesting “playback on an ‘S-Corporation’-made videocassette recorder” as an infrared command via the wireless route.

By changing the conversion table, it is possible to modify the rule according which the “playback” command is converted into the “playback on an ‘S-Corporation’-made videocassette recorder” command to a rule according to which the “playback” command is converted into a “playback on a ‘P-Corporation’-made DVD player” command. Thus, when the user buys an AV data transmitting apparatus of a different manufacturer, he or she can change the control commands to those that suit it.

As shown in FIG. 16 as an embodiment of the present invention, the flat antennas 152 and 153 are so arranged that no switch, circuit board, or connector is located in the direction in which they exhibit the maximum gain. Moreover, in a case where the AV data receiving apparatus is fixed to a display apparatus, the flat antennas 152 and 153 are so arranged that none of the faces of the display apparatus casing is located in the direction in which they exhibit the maximum gain. This helps minimize the interference of conductive materials, which shield radio waves, and thereby achieve efficient transmission and reception of radio waves.

As shown in FIG. 16, the AV data receiving apparatus is installed with its face with the buttons 142 facing upward. In this state, the antenna plane is perpendicular to the floor, and the maximum gain plane is parallel to the floor. When this apparatus is mounted on a display apparatus, it is installed with its face with the power button 141 facing upward or downward. That is, even when fixed to a display apparatus, the AV data receiving apparatus is installed with the maximum gain plane parallel to the floor. In this way, it is possible to minimize degradation of antenna performance irrespective of whether the AV data receiving apparatus is installed independently or mounted on a display apparatus.

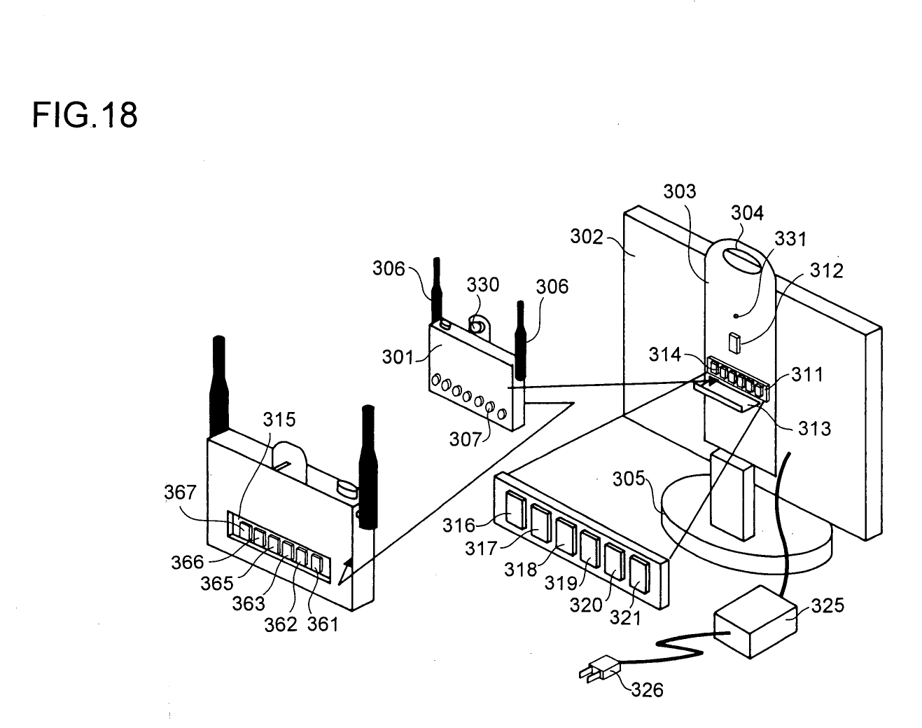

Next, with reference to FIGS. 18 to 23, an embodiment of the present invention which relates to supply of power will be described. In FIG. 18, reference numeral 302 represents a display apparatus (here, a flat panel display such as a liquid crystal television monitor). The display apparatus 302 is supported on a base 305 designed to well withstand the weight thereof, and is fitted to a fitting plate 303 designed to well withstand the weight of the display and an AV data receiving apparatus. These are firmly fixed together so that they can be easily carried around together with a grip 304 held in the hand.

The fitting plate 303 has a screw hole 331 formed therein so as to permit an AV data receiving apparatus fitting member 313 and an AV data receiving apparatus to be fixed thereto. The fitting plate 303 also has an opening formed therein so as to expose projection-like display apparatus side power/signal relaying members 314 and a projection-like connection detecting member 312, all provided on the display apparatus. On the other hand, the AV data receiving apparatus 301 is provided with antennas 306, operation members 307, and a fixing screw 330 with which the AV data receiving apparatus is fixed to the display apparatus. Moreover, on the rear face of the AV data receiving apparatus, there are provided recess-like AV data receiving apparatus side power/signal relaying members 315 so as to face away from the operation members 306.

The display apparatus receives electric power from an AC power outlet by way of a power plug 326 and an AC adapter 325. The display apparatus side power/signal relaying members 314 include a signal GND terminal 316, a video signal terminal 317, a left sound signal terminal 318, a right sound signal terminal 319, a power GND terminal 320, and a power output terminal 321. In corresponding order, the AV data receiving apparatus side power/signal relaying members 315 include a signal GND terminal 361, a video signal terminal 362, a left sound signal terminal 363, a right sound signal terminal 365, a power GND terminal 366, and a power terminal 367.

The AV data receiving apparatus 301 has its lower portion fixed by the AV data receiving apparatus fitting member 313, and has its upper portion fixed to the screw hole 331 with the fixing screw 330. In this state, the projection-like display apparatus side power/signal relaying members 314 fit into the recess-like AV data receiving apparatus side power/signal relaying members 315, with the result that the display apparatus side signal/power terminals (316 to 321) are easily and accurately connected to the corresponding terminals (361 to 367) constituting the AV data receiving apparatus side power/signal relaying members 351. In this way, the AV data receiving apparatus 301 can easily be fixed to the display apparatus 302, and necessary wiring is finished simultaneously. This helps to reduce the time and trouble required for wiring, to prevent wrong and unnecessary wiring, and thereby to reduce the costs and to improve the outer appearance

The AV data receiving apparatus 301 may be so configured as to receive electric power from an AC adapter or the like just as does the display apparatus 302. However, using two AC adapters is inconvenient in that it requires more AC power outlets and more wiring, leading to an unsightly look and other problems.

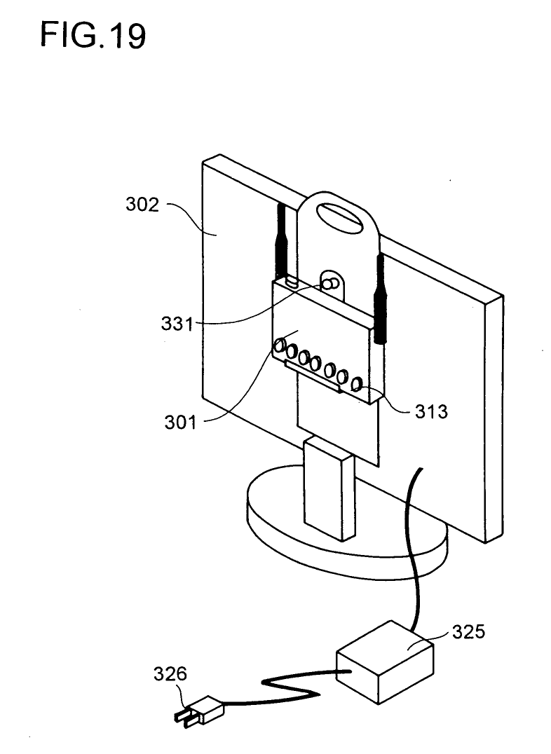

In this embodiment, while the display apparatus side power/signal relaying members 314 include the power GND terminal 320 and the power input/output terminal 321, the corresponding terminals, namely the power GND terminal 366 and power input terminal 367, are provided on the AV data receiving apparatus side. Thus, via these terminals, electric power can be fed from the display apparatus 302 to the AV data receiving apparatus 301, and therefore there is no need to separately provide a power supply such as an AC adapter on the AV data receiving apparatus side. FIG. 19 shows these apparatuses in the connected state.

Furthermore, in this embodiment, when the AV data receiving apparatus is fitted, only while the connection detecting member 312 is being pressed, electric power is output via the power input/output terminal 321. This helps prevent the power output from being short-circuited to, for example, ground as a result of a metal part touching the power input/output terminal 321 or the like when the AV data receiving apparatus 301 is not fitted. The other control, such as that for supplying electric power only when a detector has detected something, is conventionally well known, and therefore no detailed description thereof will be given. In this embodiment, the display apparatus 302 is a flat display. However, this is not to limit the present invention; that is, a CRT display or the like may be used instead.

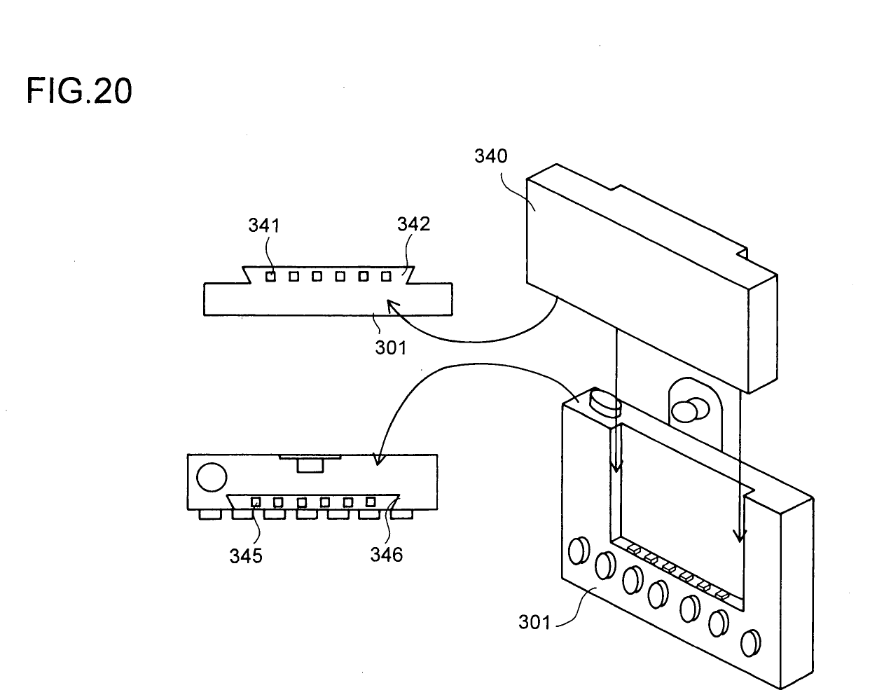

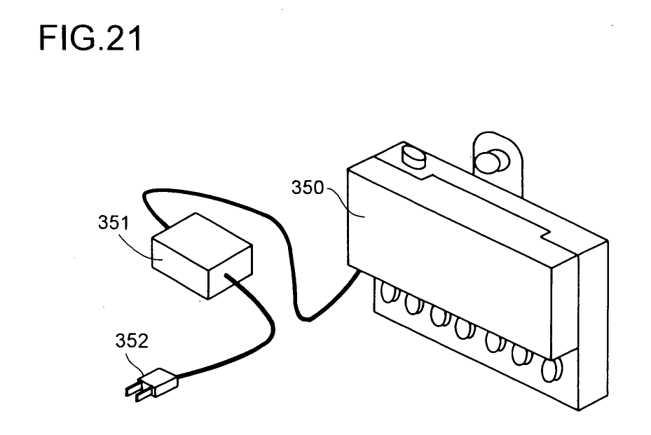

FIG. 20 shows an embodiment in which a battery is used. Reference numeral 340 represents a battery, which has, on the bottom face thereof, connection terminals 341 for connection with an external apparatus, and has, on a side face thereof, a tenon-like engagement projection 342. The AV data receiving apparatus 301′ is provided with connection terminals 345 for connection with the battery 340, and has a mortise-like engagement recess 346. The engagement projection 342 of the battery 340 engages with the engagement recess 346 of the AV data receiving apparatus 301′, and thereby these are fixed together. The connection terminals 341 of the battery are connected to the connection terminals 345 of the battery, and thereby these are integrated together, resulting in the battery-equipped AV data receiving apparatus 350 shown in FIG. 21. The battery-equipped AV data receiving apparatus 350 can also be supplied with electric power from outside by way of a power plug 352 and an AC adapter 351. This electric power is used as driving power for the battery-equipped AV data receiving apparatus. Thus, the battery-equipped AV data receiving apparatus 350 operates from both AC power and the battery. Moreover, when the battery is in a chargeable state, it can be charged with the electric power supplied from the AC power.

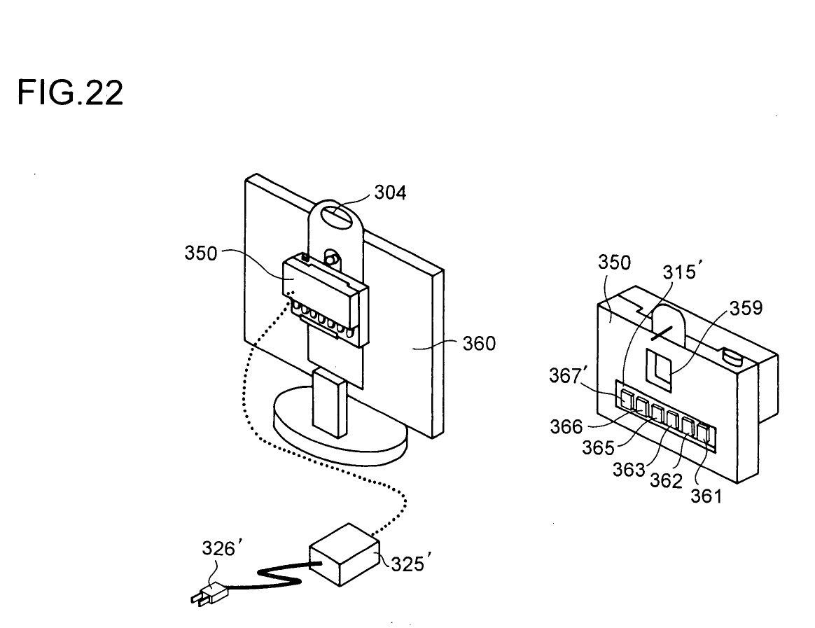

As shown in FIG. 22, the battery-equipped AV data receiving apparatus 350 has a recess 359 in the rear face thereof Thus, even when it is fitted to the display apparatus 302, the connection detecting member 312 is not pressed, and therefore no electric power is supplied. In this case, in this embodiment, the power input/output terminal 321 serves as a power input terminal. Accordingly, the terminal of the battery-equipped AV data receiving apparatus 350 which corresponds to the power input/output terminal 321 serves as a power output terminal, and thus the display apparatus is supplied with electric power.

In this way, the AV data receiving apparatus, display apparatus, and battery serving as a power source are integrated together, and operate without being supplied with electric power from outside. In addition, AV data is received wirelessly. Thus, the display apparatus 360 operates perfectly wirelessly without any connection to the outside world via an AC or DC power line or via an antenna line, and can readily be carried around with the grip 304 held in the hand.

Even in a case where no battery is provided, so long as the AV data receiving apparatus 301 is capable of feeding electric power to the display apparatus, electric power can be supplied to the AV data receiving apparatus and the display apparatus via the power plug 326′ and the AC adapter 325′. That is, it is possible to eliminate the AV adapter or the like for the display apparatus and supply all the electric power needed via a single AC line.

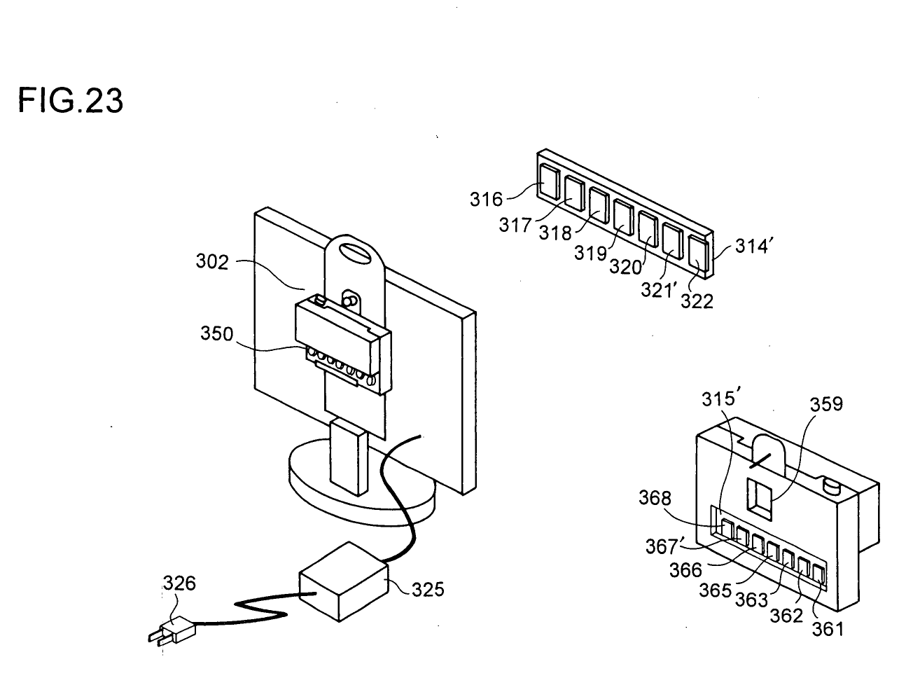

As shown in FIG. 23, if the AV data receiving apparatus side power/signal relaying members 315′ include a power/charge input terminal 368 and the display apparatus side power/signal relaying members 314′ include a power/charge output terminal 322, it is possible to drive and charge the battery-equipped AV data receiving apparatus 350 by using the electric power supplied to the display apparatus 302 via the power plug 326 and the AC adapter 352. The technology used here to achieve charging is conventionally well known in the field of PCs (personal computers) and the like, and therefore no detailed description thereof will be given.

The perfectly wireless display apparatus 360 shown in FIG. 22 and the integrated system shown in FIG. 1, which is composed of the AV data receiving apparatus 3 and the AV data transmitting apparatus 4, are, in the respective embodiments, described as being completed by the user who assembles together a plurality of apparatuses. It is, however, also possible to previously incorporate an AV data receiving apparatus and a battery in a display apparatus. Likewise, the AV data transmitting apparatus shown in FIG. 1 may be an AV unit incorporated in a AV data displaying/reproducing apparatus.

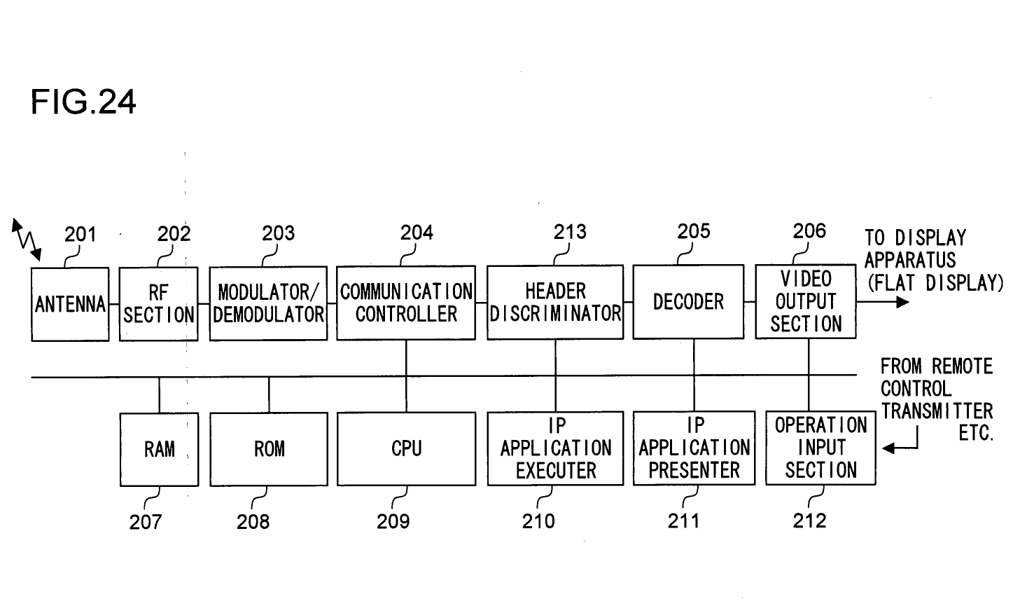

FIG. 24 shows a block diagram of an example of the present invention. Reference numeral 201 represents an antenna that actually transmits and receives a radio wave. Reference numeral 202 represents an RF section that performs up-conversion to the wireless frequency and down-conversion from the wireless frequency to the frequency that can be dealt with by digital circuitry. The RF section 202 includes an amplifier circuit and other circuits peculiar to wireless circuitry. Reference numeral 203 represents a modulator/demodulator that modulates and demodulates data. Reference numeral 204 represents a communication controller that controls communication to transmit image data and to transmit and receive control commands and asynchronous data. Reference numeral 205 represents a decoder that decompresses the image data fed thereto from the communication controller 204. Reference numeral 206 represents a video output section that achieves connection to an unillustrated external unit (for example, a display unit or image recording unit). Reference numeral 207 represents a RAM that is used as a working area by a CPU.

Reference numeral 208 represents a ROM in which programs and tables used by the CPU are stored. Reference numeral 209 represents a CPU that performs overall control. Reference numeral 210 represents an IP application executer that processes protocols related to the Internet protocol and that executes Internet applications. Reference numeral 211 represents an IP application presenter that produces screens for Internet applications. The screens produced here are displayed on an external display unit through the video output section 205. Reference numeral 212 represents an operation input section, through which entry of both Internet applications and commands for controlling AV data transmitting apparatus side unit is performed.

The distinctive feature of the present invention is the provision of a header discriminator 213, of which a detailed description will be given below. Headers need to be discriminated to know whether transmitted and received data packets are AV data, control commands for AV-related units, or Internet protocol (IP) packets. This is because AV data needs to be sent to the decoder, control commands for AV apparatuses need to be interpreted and processed as control commands, and IP-related packets (including address analysis protocols) need to be subjected to IP-related processing.

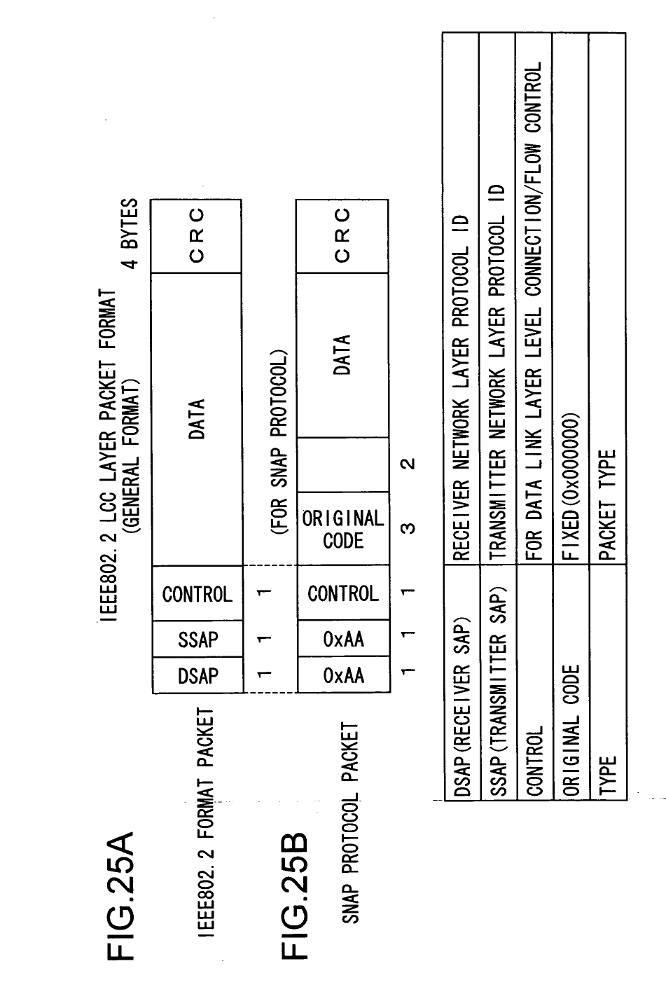

To achieve such discrimination, in the present invention, the packet format complying with IEEE802.2 is used. In FIG. 25, at (A) is shown the packet format complying with IEEE802.2, and at (B) is shown the SNAP protocol packet format that is generally used as a 802.2-complying format. The SNAP format is one method of implementing the 802.2 format. Here, IP has 0800 (hexadecimal) in the “TYPE” field. For example, “TYPE”=A000 (hexadecimal) for AV data, and “TYPE”=A001 (hexadecimal) for AV control data. AV control data may be AV/C commands that are used to control AV equipment according to IEEE1394, or may be commands in the format complying with Association for Electric Home Appliances which are used in infrared remote control in Japan. Different “TYPE” fields may be assigned to those two formats. AV data may be in the format formulated in IEC61883.

IEC61883 has an internal timer, and thus permits output synchronous with a clock at the output stage. Providing a packet header discriminator and using packet headers in the IEEE802.2 and SNAP protocol formats as in this embodiment permits even a PC software program that has conventionally been handling the IP protocol to distinguish among the IP protocol, AV data, and commands simply by discriminating the “TYPE” field. Thus, by providing the receiving side with a packet header discriminator that interprets those formats, it is possible to readily classify IP and AV data. This helps simplify the configuration of the receiving apparatus.

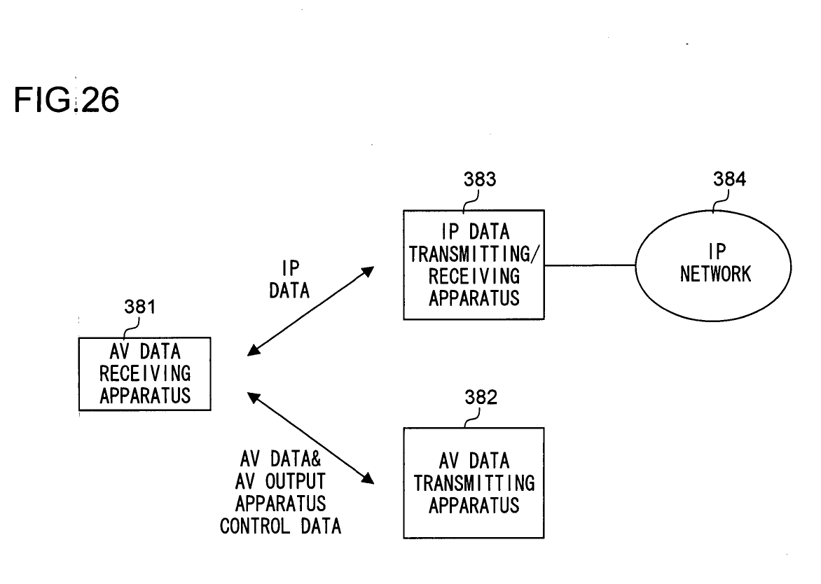

FIG. 26 shows an embodiment of the AV data receiving apparatus that connects to, as a destination of connection achieved by the Internet protocol, an access point (AP) from which IP packets are received, that negotiates with, as an image source, an AV data source about the rate, whether there has been any corrected error or not, whether there has been any delayed acknowledgement or not, etc., and that receives AV data from the AV data source.

Here, reference numeral 381 represents an AV data receiving apparatus, and reference numeral 382 represents an AV data transmitting apparatus. No AV data displaying/reproducing apparatus or AV data output apparatus is shown. Reference numeral 383 represents an IP data transmitting/receiving apparatus that transmits and receives Internet-related packets. The IP data transmitting/receiving apparatus 383 is connected to the Internet (IP network) 384. For example, with the wireless LAN protocol of IEEE802.11, in a wireless network that is connected via an access point to an outside-world network, an apparatus within the wireless network can exchange data only with the access point. This is not particularly inconvenient in the case of an IP network, because it is connected to the outside world via an AP.

However, in a case where the image source is based on a system other than an IP network (for example, a home videocassette recorder), the videocassette recorder is not connected to an AP, and thus cannot receive image data via an AP. In this case, the AV data receiving apparatus adjusts the band width with the image source or with a node for adjusting the band width, and exchanges AV data directly with the image source. Accordingly, the AV data receiving apparatus 381 transmits and receives Internet-related data to and from an access point, and simultaneously connects to the AV data transmitting apparatus for images. Thus, the AV data receiving apparatus 381 achieves Internet and AV data applications simultaneously.

Although the AV data receiving apparatus and the AV data displaying/reproducing apparatus have been described as separate apparatuses, it is also possible to integrate together the AV data receiving apparatus and the AV data displaying/reproducing apparatus to realize a wireless AV data displaying/reproducing apparatus. This makes it possible to realize an apparatus that permits AV data to be enjoyed wirelessly at any time without requiring an AV data receiving apparatus to be connected later.

Likewise, although the AV data transmitting apparatus and the AV data output apparatus have been described as separate apparatuses, it is also possible to integrate together the AV data transmitting apparatus and the AV data output apparatus to realize a wireless AV data output apparatus. This makes it possible to realize an apparatus that permits AV data to be transmitted wirelessly at any time without requiring an AV data transmitting apparatus to be connected later.

Industrial Applicability

As described in detail hereinbefore, according to the present invention, it is possible to realize an AV data transmitting apparatus having an image quality switching capability which permits effective use of a radio wave band.

According to the present invention, it is possible to realize an AV data transmitting apparatus having an image quality switching capability which offers higher reliability in AV data transfer by controlling the image quality and number of times of resending.

According to the present invention, it is possible to realize an AV data transmitting apparatus having an image quality switching capability which permits confirmation of the currently set image quality level and which permits changing of the image quality at any time with no indication on the screen

According to the present invention, it is possible to realize an AV data transmitting apparatus that permits confirmation of the currently set frequency by the use of a frequency switch and permits changing of the transfer chanel with no indication on the screen According to the present invention, it is possible to realize an AV data transmitting apparatus that uses a part of the 2.4 GHz band around the 14th channel and that thereby achieves image transfer with less noise as a result of less interference from the Bluetooth system.

According to the present invention, it is possible to convert received control signals into commands that suit the connected AV unit. Thus, the remote control signals received by an AV data receiving apparatus do not need to be those for the connected AV unit. Moreover, the signals are checked so as not to send unnecessary remote control signals. This prevents other AV units from being erroneously controlled.

According to the present invention, by changing tables, it is possible to operate a number of AV units. It is possible to generate commands such as those requesting “video playback on an ‘S Corporation’-made videocassette recorder” and “video playback on a ‘P Corporation’-made DVD player.” Moreover, by making a setting such that television channel commands are not transmitted, it is possible to prevent a television monitor located near an AV data transmitting apparatus from being erroneously controlled.

According to the present invention, by making the operation command receiver movable, it is possible to permit the user to perform remote control operation from in front of a display apparatus. Moreover, even in a case where an AV data receiving apparatus is fitted on a rear face of a display apparatus such as a flat display so as not to spoil its slim design, the photoreceiver can be placed in such a position that the user of the display apparatus can easily perform remote control operation.

According to the present invention, the photoreceiver of a display apparatus can be shared by an AV data receiving apparatus. This makes it possible to transfer operation commands from the AV data receiving apparatus to the an AV data transmitting apparatus without providing an extra photoreceiver.

According to the present invention, by adding a reflective member, it is possible to control an AV data receiving apparatus by remote control without providing an extra photoreceiver or moving an existing photoreceiver.

According to the present invention, it is possible to fit the movable photoreceiver to the display apparatus. This makes it easy for the user to fix the photoreceiver.

According to the present invention, it is possible to select and add an antenna. This makes it possible to select perception performance that suits the radio wave condition at the user's site.

According to the present invention, the fitting portion for an external antenna and that for an infrared light-receiving element can be provided on the same face. This makes it easy for the user to connect the units together.

According to the present invention, an external antenna and an infrared light-receiving element are integrated together. This permits the antenna and the infrared light-receiving element to be fitted simultaneously. This reduces the work of the user.

According to the present invention, an AV data receiving apparatus is provided with operation switches. Thus, even without a remote control transmitter, it is possible to operate AV units connected to an AV data transmitting apparatus or AV data transmitting apparatus.

According to the present invention, an AV data receiving apparatus can kill signals that do not need to be wirelessly sent to an AV data transmitting apparatus. This permits effective use of a radio wave band, prevents unnecessary operation on the AV data transmitting apparatus, and prevents erroneous control of a unit that is located close to the AV data transmitting apparatus but is not supposed to be operated.

According to the present invention, an AV data receiving apparatus can convert commands. This makes it possible to switch and control, from the AV data receiving apparatus, a number of units located around an AV data transmitting apparatus. Moreover, by making it possible to convert the switching commands of the AV data receiving apparatus itself, it is possible to perform a number of operations and operate a number of units with a few switches.

According to the present invention, an antenna, a circuit board, and other components are arranged in such a way as to minimize the obstruction of the radio wave received by the antenna. This makes it possible to transmit and receive the radio wave efficiently.

According to the present invention, it is possible to supply electric power from a display apparatus. This eliminates the need to provide an AV data receiving apparatus with a separate unit such as an AC adapter. This helps reduce costs, simplify the wiring, and improve the outer appearance.

According to the present invention, it is possible to supply electric power from an AV data receiving apparatus to a display apparatus. This eliminates the need to provide the display apparatus with a separate unit such as an AV adapter. This helps reduce costs, simplify the wiring, and improve the outer appearance.

According to the present invention, a battery is used as a power source. This makes it possible to realize a perfectly wireless television system.

According to the present invention, a display apparatus is provided with a mechanism for mounting an AV data receiving apparatus. This eliminates the need to secure an extra space for the AV data receiving apparatus, and thus makes it easy to install the AV data receiving apparatus.

According to the present invention, an AV data receiving apparatus is fitted on the rear face of a display apparatus. Thus, even with a flat display, it is possible to fit the AV data receiving apparatus without spoiling the neat design of the display apparatus having few components located on the front face.

According to the present invention, it is possible to carry an AV data receiving apparatus and a display apparatus simultaneously and easily with a single hand. When this is combined with the aforementioned construction, it is possible to carry an AV data receiving apparatus, a display apparatus, and a battery simultaneously and freely. Thus, it is possible to realize a perfectly wireless display apparatus that can be viewed anywhere, even while it is being carried around.

According to the present invention, the receiving side is provided with a packet header discriminator that interprets predetermined formats. This makes it possible to distinguish among the IP protocol, commands, and AV-related data. This helps easily realize a receiving apparatus that distinguishes between IP and AV data.

According to the present invention, connection is made to separate apparatuses for IP data and AV data. This makes it possible to exchange IP data and AV data simultaneously on the same channel of the same medium between a transmitting side and a receiving side. That is, connection can be made to two destinations simultaneously, namely an IP data provider and an AV data transmitting apparatus.

According to the present invention, an AV data receiving apparatus is previously incorporated in a receiving apparatus. This makes it possible to view information of an AV unit located at a remote place without additional provision of an extra AV data receiving apparatus or the like.

According to the present invention, an AV data transmitting apparatus is previously incorporated in an AV unit or the like. This makes it possible to transfer AV data to an AV data receiving apparatus located at a remote place without additional provision of an extra AV data transmitting apparatus or the like.

1. An AV data transmitting apparatus that transmits AV data wirelessly and that transmits and receives asynchronous data containing control data,
wherein the AV data transmitting apparatus comprises
a quality change setter for changing a setting in a compression ratio of the AV data, the quality change setter being capable of changing a communication bandwidth with which the AV data is transmitted.

2. An AV data transmitting apparatus that transmits AV data wirelessly and that transmits and receives asynchronous data containing control data,
wherein the AV data transmitting apparatus comprises
a quality change setter for permitting a user to change a compression ratio of the AV data, the quality change setter being capable of changing not only a compression ratio with which the AV data is transmitted but also reliability of communication.

3. The AV data transmitting apparatus according to claim 1,
wherein the quality change setter is a switch added to the AV data transmitting apparatus, the switch being switchable even during communication.

4. An AV data transmitting apparatus that transmits AV data wirelessly and that transmits and receives asynchronous data,
wherein the AV data transmitting apparatus comprises
a channel switcher for switching channels used for wireless transmission.

5. The AV data transmitting apparatus according to claim 4,
wherein wireless transmission is performed in a 2.4 GHz band (from 2 400 MHz to 2 497 MHz), and channels switchable by a user include a part of the band above a 13th channel (with a central frequency of 2 472 MHz).

6. An AV data transmitting apparatus that transmits AV data wirelessly and that transmits and receives asynchronous data,
wherein the AV data transmitting apparatus comprises
a command converter for selecting control data from the asynchronous data and converting the control data according to a predetermined rule and
a command transmitter for feeding a command obtained through conversion by the command converter to an external apparatus.

7. The AV data transmitting apparatus according to claim 6,
wherein the command converter holds a rewritable conversion rule that can be changed from the external apparatus.

8. An AV data receiving apparatus that receives wirelessly transmitted AV data and that transmits and receives asynchronous data containing control data,
wherein the AV data receiving apparatus comprises
a command receiver for receiving an operation command, the command receiver being movable.

9. An AV data receiving apparatus that receives wirelessly transmitted AV data and that transmits and receives asynchronous data containing control data,
wherein the AV data receiving apparatus has a command receiver externally fitted thereto for receiving an operation command.

10. The AV data receiving apparatus according to claim 8,
wherein the movable command receiver can be placed in a position in which the command receiver can receive remote control operation signals from a front-face side of an AV data displaying/reproducing apparatus.

11. The AV data receiving apparatus according to claim 9,
wherein a movable command receiver can be placed in a position in which the command receiver can receive remote control operation signals from a front-face side of an AV data displaying/reproducing apparatus.

12. The AV data receiving apparatus according to claim 8,
wherein the AV data receiving apparatus is connected to an AV data displaying/reproducing apparatus via a signal line so that an operation command receiver of the AV data receiving apparatus is shared as a command receiver of the AV data displaying/reproducing apparatus.

13. The AV data receiving apparatus according to claim 9,
wherein the AV data receiving apparatus is connected to an AV data displaying/reproducing apparatus via a signal line so that an operation command receiver of the AV data receiving apparatus is shared as a command receiver of the AV data displaying/reproducing apparatus.

14. The AV data receiving apparatus according to claim 10,
wherein the AV data receiving apparatus is connected to an AV data displaying/reproducing apparatus via a signal line so that an operation command receiver of the AV data receiving apparatus is shared as a command receiver of the AV data displaying/reproducing apparatus.

15. The AV data receiving apparatus according to claim 11,
wherein the AV data receiving apparatus is connected to an AV data displaying/reproducing apparatus via a signal line so that an operation command receiver of the AV data receiving apparatus is shared as a command receiver of the AV data displaying/reproducing apparatus.

16. An AV data receiving apparatus that receives wirelessly transmitted AV data and that transmits and receives asynchronous data containing control data,
wherein the AV data receiving apparatus comprises
an operation command receiver and
a light reflector for feeding light to the operation command receiver by reflecting the light.

17. The AV data receiving apparatus according to claim 8,
wherein the AV data displaying/reproducing apparatus has a portion to which the operation command receiver is fitted.

18. An AV data receiving apparatus that receives wirelessly transmitted AV data and that transmits and receives asynchronous data containing control data,
wherein the AV data receiving apparatus has an external antenna data reception interface and a command reception interface arranged on a same face of the AV data receiving apparatus.

19. The AV data receiving apparatus according to claim 8,
wherein an external antenna and the command receiver are integrated together.

20. An AV data receiving apparatus that receives wirelessly transmitted AV data and that transmits and receives asynchronous data containing control data,
wherein the AV data receiving apparatus comprises
a command switch for generating an operation command.

21. An AV data receiving apparatus that receives wirelessly transmitted digital AV data and that transmits and receives asynchronous data containing control data,
wherein the AV data receiving apparatus comprises
an IR command receiver and a command converter.

22. The AV data receiving apparatus according to claim 21,
wherein the command converter is partially rewritable through setting from outside so as to be capable of being switched to a different function.

23. An AV data receiving apparatus that receives wirelessly transmitted AV data and that transmits and receives asynchronous data containing control data,
wherein an antenna is arranged with a maximum gain plane of the antenna kept at a substantially right angle to a surface of a circuit board provided inside the AV data receiving apparatus.

24. An AV data receiving apparatus that receives wirelessly transmitted digital AV data and that transmits and receives asynchronous data containing control data,
wherein the AV data receiving apparatus comprises
a power supply interface for feeding electric power to the AV data receiving apparatus.

25. An AV data receiving apparatus that receives wirelessly transmitted digital AV data and that transmits and receives asynchronous data containing control data,
wherein the AV data receiving apparatus comprises
a power supply for feeding electric power to the AV data receiving apparatus and
a power supply interface for feeding electric power to an AV data displaying/reproducing apparatus.

26. The AV data receiving apparatus according to claim 21,
wherein the AV data receiving apparatus operates from a battery as a power source so that the AV data receiving apparatus can be charged when the AV data displaying/reproducing apparatus is operating from another power source.

27. An AV data displaying/reproducing apparatus that permits the AV data receiving apparatus according to claim 8 to be fitted and fixed thereto.

28. The AV data displaying/reproducing apparatus according to claim 27,
wherein the AV data displaying/reproducing apparatus is a flat display apparatus having, on a rear face thereof, a mechanism that permits the AV data receiving apparatus to be fitted thereto so that a flat panel display and the AV data receiving apparatus can be carried around together.

29. The AV data displaying/reproducing apparatus according to claim 28,
wherein a flat panel display holder for holding the flat panel display upright has a mechanism that permits the AV data receiving apparatus to be fitted thereto so that the AV data receiving apparatus can be fitted to a portion of the AV data displaying/reproducing apparatus where a weight of the flat panel display can be supported.

30. An AV data receiving apparatus that receives wirelessly transmitted digital AV data and that transmits and receives asynchronous data containing control data,
wherein the AV data receiving apparatus comprises
a header discriminator for checking whether received data is image data, control data, or data relating to an Internet protocol,
an IP application executer for executing an Internet application, and
an IP application presenter for producing a IP application screen.

31. The AV data receiving apparatus according to claim 30,
wherein the AV data receiving apparatus connects to the Internet via an apparatus separate from an AV data transmitting apparatus.

32. An AV data receiving apparatus that receives AV data transmitted wirelessly from an AV data transmitting side and that transmits and receives asynchronous data containing control data wirelessly to and from the AV data transmitting side,
wherein the AV data receiving apparatus comprises
a command receiver of which a receiver section for receiving an optical signal carrying an operation command is movable.

33. An AV data receiving apparatus that receives AV data transmitted wirelessly from an AV data source side and that receives an operation command from a remote control transmitter to transmit asynchronous data containing control data wirelessly to the AV data source side,
wherein a command receiver for receiving the operation command is movable.

34. The AV data transmitting apparatus according to claim 1,
wherein the quality change setter changes the communication bandwidth by increasing or decreasing the communication bandwidth, and is capable of accordingly increasing or decreasing either a period for resending the AV data or a bandwidth for other communication.

35. The AV data transmitting apparatus according to claim 2,
wherein the quality change setter is a switch added to the AV data transmitting apparatus, the switch being switchable even during communication.

36. The AV data receiving apparatus according to claim 9,
wherein an external antenna and the command receiver are integrated together.

37. The AV data receiving apparatus according to claim 16,
wherein an external antenna and the command receiver are integrated together.

38. The AV data receiving apparatus according to claim 18,
wherein an external antenna and the command receiver are integrated together.
